(19) United States
(12) Patent Application Publication
(10) Pub. No.: US 2025/0200340 A1
(43) Pub. Date: Jun. 19, 2025

(54) INFORMATION PROCESSING APPARATUS, APPLICATION GENERATION SYSTEM, AND APPLICATION GENERATION METHOD

(71) Applicant: Seiichi KONDO, TOKYO (JP)

(72) Inventor: Seiichi KONDO, TOKYO (JP)

(21) Appl. No.: 18/973,115

(22) Filed: Dec. 9, 2024

(30) Foreign Application Priority Data
Dec. 15, 2023 (JP) 2023-211915
Aug. 28, 2024 (JP) 2024-146495

(51) Int. Cl. G06N 3/0475

(52) U.S. Cl. CPC G06N 3/0475

(57) ABSTRACT

An information processing apparatus is communicably connected with a terminal device and a generative artificial intelligence (AI) system through a network. The information processing apparatus includes processing circuitry. The processing circuitry transmits data based on the sample data to the generative AI system in response to receiving sample data for generating application from the terminal device. The processing circuitry transmits setting information for generating the application and information for calling a predefined function to the generative AI system at least once. The processing circuitry generates the application based on parameters included in the request by executing the predefined function in response to receiving a request for generation of the application from the generative AI system. The request is generated by the generative AI system based on the data, the setting information, and the information for calling the predefined function.

### CROSS-REFERENCE TO RELATED APPLICATIONS

This patent application is based on and claims priority pursuant to 35 U.S.C. § 119 (a) to Japanese Patent Application No. 2023-211915, filed on Dec. 15, 2023, and No. 2024-146495, filed on Aug. 28, 2024, in the Japan Patent Office, the entire disclosure of which is hereby incorporated by reference herein.

### BACKGROUND

### Technical Field

The present disclosure relates to an information processing apparatus, an application generation system, and an application generation method.

### Related Art

Application development needs a process referred to as programming (coding) in which a developer inputs source code using a keyboard or other device. However, it takes a lot of time and cost to learn the grammar of a programming language and efficient programming. A programming support technique has been proposed in which the input of program code is reduced or eliminated.

A programming method using artificial intelligence (AI) has been proposed. A technique has been proposed that acquires text data from conversational sentences, refers to a program code database in which one or more program codes are stored in association with extracted contexts, a program grammar analysis database, and an automatic program generation knowledge database in which programs made efficient for processing operations to be implemented are associated, and generates one or more programs corresponding to the extracted contexts.

### SUMMARY

Embodiments of the present disclosure described herein provide a novel information processing apparatus communicably connected with a terminal device and a generative artificial intelligence (AI) system through a network. The information processing apparatus includes processing circuitry. The processing circuitry transmits data based on the sample data to the generative AI system in response to receiving sample data for generating application from the terminal device. The processing circuitry transmits setting information for generating the application and information for calling a predefined function to the generative AI system at least once. The processing circuitry generates the application based on parameters included in the request by executing the predefined function in response to receiving a request for generation of the application from the generative AI system. The request is generated by the generative AI system based on the data, the setting information, and the information for calling the predefined function.

Embodiments of the present disclosure described herein provide a novel application generation system including a terminal device, a generative AI system, and an information processing apparatus. The information processing apparatus is communicably connected with the terminal device and the generative AI system through a network. The terminal device includes device circuitry to transmit sample data for generating application to the generative AI system. The information processing apparatus includes processing circuitry. The processing circuitry transmits data based on the sample data to the generative AI system in response to receiving sample data for generating application from the terminal device. The processing circuitry transmits setting information for generating the application and information for calling a predefined function to the generative AI system at least once. The processing circuitry generates the application based on parameters included in the request by executing the predefined function in response to receiving a request for generation of the application from the generative AI system. The request is generated by the generative AI system based on the data, the setting information, and the information for calling the predefined function.

Embodiments of the present disclosure described herein provide a novel application generation method for generating application, executed by an information processing apparatus communicably connected with a terminal device and a generative AI system through a network. The method includes: in response to receiving sample data for generating application from the terminal device, transmitting data based on the sample data to the generative AI system; transmitting setting information for generating the application and information for calling a predefined function to the generative AI system at least once; and in response to receiving a request for generation of the application from the generative AI system, generating the application based on parameters included in the request by executing the predefined function, the request being generated by the generative AI system based on the data, the setting information, and the information for calling the predefined function.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram illustrating processing from when a generative AI system requests execution of a function for sample data input by a user to when an information processing system generates an application;

FIG. 2A is a diagram illustrating an application generation page displayed by a user terminal;

FIG. 2B is a diagram illustrating a screen of an inventory management application for restaurants displayed by an estimate application for the restaurants generated by transmission of sample data of FIG. 2A;

FIG. 3 is a diagram illustrating a system configuration of an application generation system;

FIG. 4 is a diagram illustrating a hardware configuration of the information processing system, the user terminal, and the developer terminal;

FIG. 5 is a diagram illustrating a functional configuration of the information processing system, the user terminal, and the developer terminal;

FIG. 6 is a diagram illustrating a request message that the information processing system calls the application programming interface (API) of a generative AI system when the user operates the user terminal to transmit sample data to the information processing system;

FIG. 7 is a diagram illustrating a response message of the generative AI system in response to the request message of FIG. 6;

FIG. 8 is a diagram illustrating a request message transmitted to the generative AI system after the information processing system generates or updates an application for an application service;

FIG. 9 is a diagram illustrating an example of a response message of the generative AI system in response to the request message of FIG. 8;

FIG. 10 is a sequence diagram illustrating processing of supporting application development by the information processing system;

FIG. 11 is a diagram illustrating sample data that the user uses as input to the generative AI system;

FIGS. 12A and 12B are diagrams illustrating a display of an application generation page displayed by the user terminal when the user develops an application;

FIG. 13 is a diagram illustrating an estimate management application screen displayed by the estimate management application when a uniform resource locator (URL) where an application is generated is pressed;

FIG. 14 is a diagram illustrating a display of an application generation page in which the user has added a chat message to the application generation page of FIG. 12B;

FIG. 15 is a diagram illustrating an estimate management application screen displayed by the estimate management application when a URL of an updated application is pressed;

FIG. 16 is a diagram illustrating a portal screen of an application service displayed by the user terminal;

FIG. 17 is a sequence diagram illustrating that the information processing system utilizes the cooperation of two web browsers in the user terminal to generate or update an application of an application service;

FIG. 18 is another sequence diagram illustrating that the information processing system utilizes the cooperation of two web browsers in the user terminal to generate or update the application of the application service;

FIG. 19 is a diagram illustrating processing from when a generative AI system 50 requests the information processing system to execute a function in response to a chat message input by the user until when the information processing system generates an application; and

FIG. 20 is a diagram illustrating a functional configuration of the information processing system, the user terminal, and the developer terminal in the case where an application service and the information processing system are integrated.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

A description is given below of an information processing system and an application generation method performed by the information processing system as an embodiment of the present disclosure with reference to the drawings.

A generative AI system such as ChatGPT® is known. The generative AI system can perform various natural language processing tasks, such as text generation, question answering, text classification, sentiment analysis, information extraction, and sentence summarization. The generative AI system such as Copilot® has been proposed, which suggests next code to be written while coding a program. In the present embodiment, a description is given below of a technique in which a user generates an application through a conversation (also referred to as a chat) with a generative AI system. In the following description, a generative AI system or a function of the generative AI system may be simply referred to as AI.

The external generative AI system may be provided as a system different from a system that provides a service related to an application, and the service related to the application and the generative AI system may be provided by the same provider.

When the user with limited expertise develops an application, the user has a first barrier and a second barrier. The first barrier is that the user doesn't know what kind of application to generate. The second barrier is that the user doesn't know how to generate an application even if the user wants to generate the application.

Since the generative AI system provides ideas, the first barrier is easily solved. The generative AI system generally learns based on a large amount of sentences on the Internet, and thus the generative AI system has knowledge of various industries and businesses. Accordingly, the generative AI system can provide wealth of ideas about the type of the application.

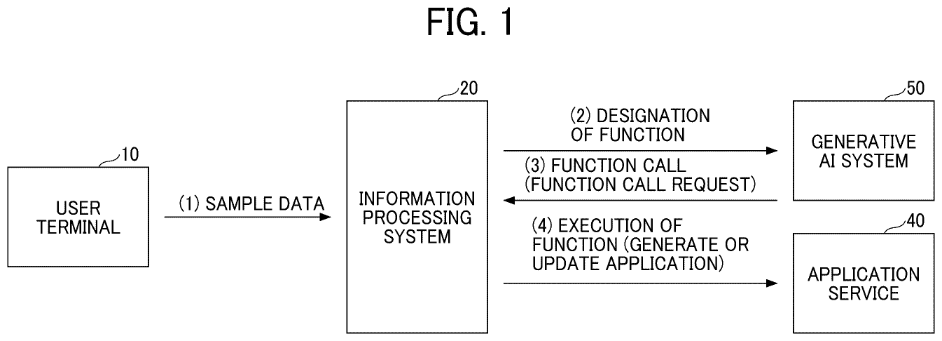

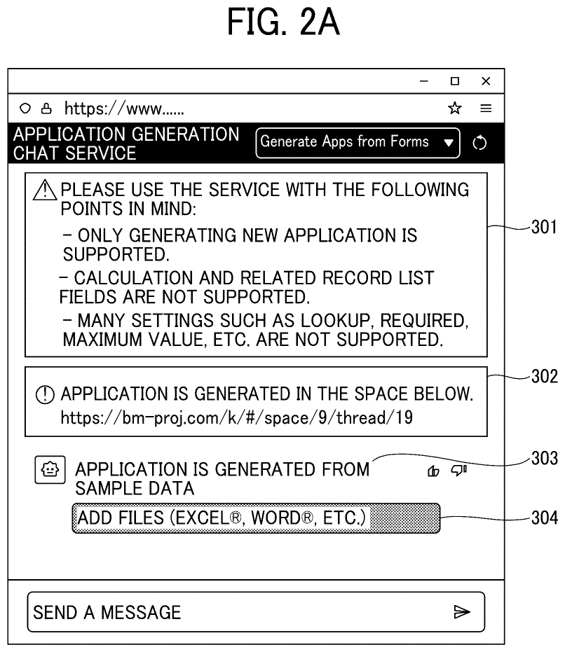

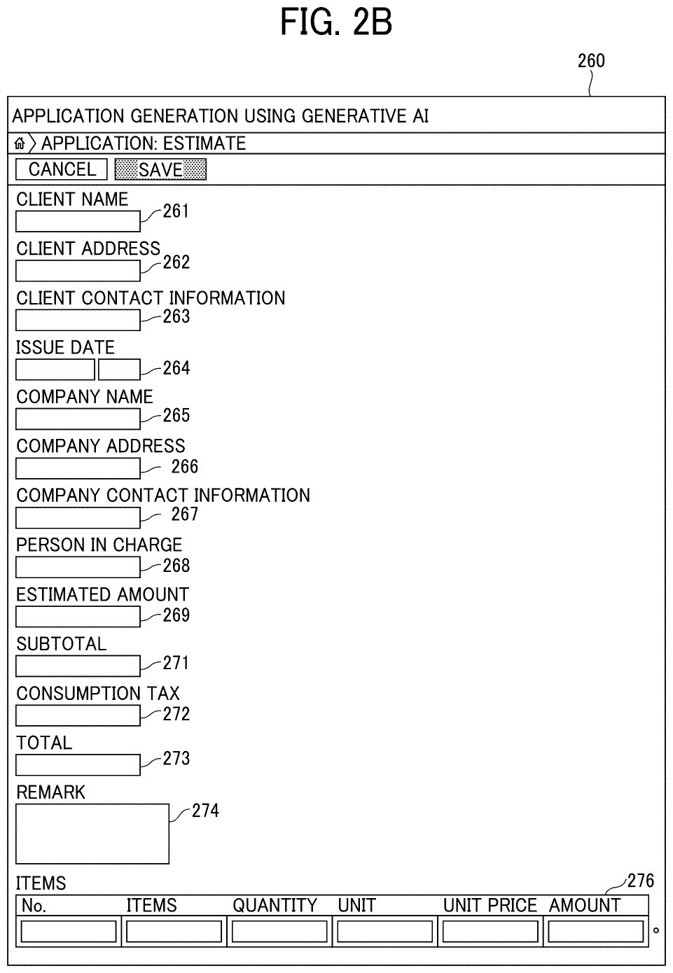

Regarding the second barrier, generally, AI including generative AI system cannot generate applications. In the present embodiment, in order to solve the second barrier, the information processing system interposes between the user and the generative AI system to use the function of calling a function (that is referred to as “function calling” or “function call”) provided by the generative AI system. A description is given below with reference to FIGS. 1 and 2.

FIG. 1 is a diagram illustrating processing from when a generative AI system 50 requests execution of a function for sample data input by a user to an information processing system 20, to when the information processing system 20 generates an application. The information processing system 20 provides a user interface (UI) when a user develops an application using the generative AI system 50. The information processing system 20 is described later. The information processing system 20 converts the sample data transmitted from a user terminal 10 into a request message for calling an application programming interface (API) published by the generative AI system 50 and an application service 40, and transmits the request message to the generative AI system 50 and the application service 40.

In step (1), the user terminal 10 transmits the sample data prepared by the user to the information processing system 20. The sample data is data serving as a sample for application development. For example, when the user causes the generative AI system 50 to develop an application that handles a table format or a database, the sample data may be a file such as a file for spreadsheet software.

In step (2), when the information processing system 20 receives the sample data input by the user, the information processing system 20 includes data based on the received sample data in a request message to transmit the data to the generative AI system 50 via the API for receiving the request message provided by the generative AI system. The information processing system 20 transmits the request message including designation of a specification of a function. The function is a program interface that performs a predetermined process with specified arguments and returns a return value as a result. This function is a function for enabling the generative AI system 50 to request the information processing system 20 to generate or update an application used on the application service 40. The information processing system 20 includes the setting of the function specification in the request message to transmit the setting to the generative AI system 50 and thus, the information processing system 20 can generate or update the application with low-code or no-code in response to the request from the generative AI system 50. The generative AI system 50 requesting the information processing system 20 to call the function is referred to as a function call. As supplementary information, the information processing system 20 can include, in the request message, system setting for notifying the generative AI system 50 of the type of application. The system setting is a general policy regarding the application to be generated, whereas the setting of the function specification is information for the information processing system 20 to designate the specification of a function to be called by the generative AI system 50 to the generative AI system 50. The system setting and the setting of the function specification are described later.

The information processing system 20 may not include the system setting or the setting of the function specification in the same request message as the data based on the received sample data. For example, the information processing system 20 may include the system setting and the setting of the function specification in a request message different from the request message including the data based on the received sample data and transmit the request message to the generative AI system 50. The information processing system 20 may also include the system setting and the setting of the function specification in different request messages to transmit the request messages to the generative AI system 50.

The information processing system 20 may transmit the system setting and the setting of the function specification for each time the information processing system 20 transmits the request message including the data based on the received sample data.

Alternatively, the information processing system 20 may transmit the system setting and the setting of the function specification only once at the beginning.

In step (3), the generative AI system 50 transmits a response message including a function call request (function call) to the information processing system 20 based on the data (that may include a history of conversation before transmission of the sample data) based on sample data included in the transmitted request message and the system setting and the setting of the function specification. The generative AI system 50 only requests the information processing system 20 to call a function, and the information processing system 20 actually executes the function. However, the generative AI system 50 includes field names (an example of a parameter) corresponding to the type of the application requested by the user in the request message.

The generative AI system 50 may not transmit the response message including the function call request to the information processing system 20 based on the history of conversation, the setting of the function specification, and the system setting. For example, the generative AI system 50 may transmit a response message including a question or a response message indicating that the content of the sample data cannot be understood to the information processing system 20.

In step (4), the information processing system 20 generates an application in response to the function call request (function call) included in the response message transmitted from the generative AI system 50. The type of application to be generated is determined in step (2) and step (3). Specifically, the information processing system 20 generates a request message for calling the API of the application service 40 from the content of the function call request (function call), and transmits the generated request message to the application service 40. In the present embodiment, such a process related to the generation of a request message may be referred to as “execution of a function” or “executing a function”. In the present embodiment, the information processing system 20 generates or updates the application of the application service 40 in response to the function call request (function call).

As described above, the user only inputs sample data to the user terminal 10, and thus the information processing system 20 can develop an application using the generative AI system 50. As a result, the second barrier is also solved.

The application generation support screen of FIG. 2A is an example of an application generation page displayed by the user terminal 10. The application generation page displays a note 301 for application generation, a space 302 (e.g., a URL space) in which the application is generated, and a message 303 indicating that the application is generated from the sample data. An adding button 304 for adding the sample data is displayed below the message 303. When the user presses the adding button 304, a file list screen is displayed, and the sample data to be transmitted to the generative AI system 50 can be selected.

FIG. 2B is a diagram illustrating an estimate management application screen 260 displayed by an estimate management application that is generated from the sample data of FIG. 2A. The estimate management application screen 260 includes input fields corresponding to item names of a client name 261, a client address 262, a client contact information 263, an issue date 264, a company name 265, a company address 266, a company contact information 267, a person in charge 268, an estimated amount 269, a subtotal 271, a consumption tax 272, a total 273, and a remark 274. The estimate management application screen 260 includes input fields corresponding to a sub-table 276.

As described later, these item names and the sub-table 276 are included in the sample data or are automatically generated based on the sample data (even if these item names and the sub-table 276 are not included in the sample data), and the generative AI system 50 and the information processing system 20 can automatically pick up items from the sample data and set the items in the items of the application.

As described above, in an application generation system 100 according to the present embodiment, the user transmits sample data such as an estimate file to the information processing system 20, and thus the information processing system 20 communicates with the generative AI system 50 and can develop an application. Since the information processing system 20 designates a function to the generative AI system 50, the generative AI system 50 can request the information processing system 20 to call the function together with the field names of the application. Then, the information processing system 20 generates or updates the application. Accordingly, the user can input the sample data such as the estimate to implement a no-code platform or low-code platform for developing the estimate management application.

An application is an abbreviation of an application program, and is a program generated by a computer in accordance with any businesses. An operating system (OS) is general-purpose software that provides basic functions and systems (e.g., file system, communication, and display control) in the operation of a computer, whereas the application provides specific functions on the OS. Examples of the application include a native application and a web application. In the present embodiment, either a native application or a web application may be developed.

The API is an interface of the application (software), and is a contact point for connecting systems to share functions and mechanisms. The API defines the specification of an interface used by applications to exchange information with each other. The API between computers is designed so that one web site communicates with another web site via hypertext transfer protocol (HTTP) or hypertext transfer protocol secure (HTTPS) communication. Communication allows one web site to use the functions of another web site. The API between computers may be referred to as a web-API.

When the API transmits a specific request (e.g., data acquisition, update, deletion, and processing), the API returns a result (e.g., data, an update result, a deletion result, and a processing result) in response to the specific request. The request may be referred to as a request message, and the result may be referred to as a response message. Calling an API indicates transmitting a request and acquiring a result in accordance with the specification of the API. Calling an API may also be referred to as executing, operating, hitting, or using.

The information for calling a function is information that enables a function provided by the information processing system 20 to be called from the outside of the information processing system, for example, the generative AI system 50. The information for calling a function includes information related to a web-API for calling the function.

The information related to the web-API for calling the function is information for enabling the generative AI system 50 to call (use) the web-API. In the present embodiment, the term “setting of function specification” (referred to as “function specification setting” in the following description) is used to indicate the information related to the web-API for calling the function. The function specification setting is information that the information processing system 20 designates the specification of the function to be called by the generative AI system 50 to the generative AI system 50. Since the generative AI system 50 calls the function to the information processing system 20 based on the setting of function specification, the information processing system 20 can analyze the function.

The function is a program interface that performs a predetermined process with specified arguments and returns a return value as a result. A developer can design the specification and function of a function, whereas API is prepared in advance for the function that have been published as being available for use by the generative AI system 50 and the application service 40. The function is one of specifications of the API, and can be set by calling the API when the API defines a method of designating the function. Calling of a function or calling request of a function indicates to a request for execution of a function.

The data based on the sample data may be either the sample data itself or data acquired by converting the sample data into another format. The generative AI system 50 uses the data based on the sample data as a sample to generate a request for generation of an application. The sample data is data used as a sample by the generative AI system 50, but the sample data may be referred to as template data, case data, original data, or item data.

A chat service is a service in which multiple users transmit and receive messages in real time. The generative AI system is a service in which the user transmits and receives messages to and from an AI in real time.

The setting information is an overall policy for generating an application, and the setting information is, for example, a description or a hint of the content of the application, or the content that is not be asked about by the user. The setting information is information that facilitates generation of a desired application when the setting information is notified to the generative AI system 50.

The system setting is information obtained by converting all or a part of the setting information into a request message for calling an API. In other words, the system setting is information obtained by converting all or a part of the setting information into the format of the API.

The parameters included in the request for generation of the application are variables that effect the behavior of the application. The contents of the parameters vary depending on the application, and for example, in the case of an application that handles a table or a database, the contents of the parameters include a field name and a data format of a field. Alternatively, the number of rows, the number of columns, the size of rows or columns, the font or color at the time of data display, and the position of a field may be included in the parameters.

The user is an end user who uses an application provided by the application service 40. The user can also develop an application. The developer is a person who performs setting to be used for application development by no-code or low-code programming on the information processing system 20. The developer sets setting information, which is described later, in the information processing system 20.

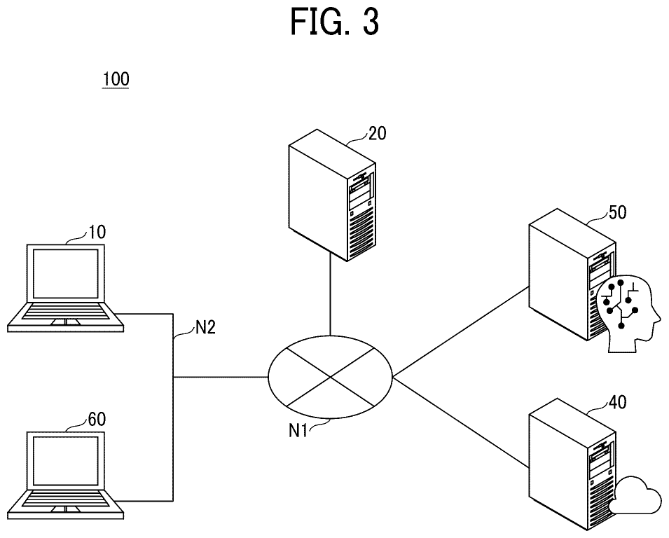

A description is given below of a system configuration of the application generation system 100 according to the present embodiment with reference to FIG. 3. FIG. 3 is a diagram illustrating the system configuration of the application generation system 100. The application generation system 100 illustrated in FIG. 3 includes the information processing system 20, the user terminal 10, and a developer terminal 60. The information processing system 20 and the user terminal 10, and the information processing system 20 and the developer terminal 60 are connected to communicate with each other via networks N1 and N2. The information processing system 20 can communicate with the generative AI system 50 and the application service 40, which is an external system, via the network N1. The user terminal 10 and the developer terminal 60 can communicate with the generative AI system 50 and the application service 40, which is an external system, via the networks N1 and N2.

The user terminal 10 and the developer terminal 60 are installed in a facility such as a facility of company and a facility of home, and are connected to the network N2. The network N2 may be a local area network, a Wi-Fi® network, a wide-area ethernet®, or a cellular network such as 4G, 5G, or 6G. The network N1 is a wide area network such as the Internet or a wide area network (WAN). The user terminal 10 and the developer terminal 60 may not be always connected to the network N2, and may be connected when the information processing system 20, the generative AI system 50, or the application service 40 is used.

The generative AI system 50 provides a service for a user to converse with an AI in a conversational manner. As a system such as the generative AI system 50, a system using large language models (LLMs) has been proposed. The LLMs are models for natural language processing that have been trained using a large amount of text data. The generative AI system 50 captures a huge amount of text in advance and learns knowledge from the text using deep learning or reinforcement learning. The generative AI system 50 uses this knowledge to provide a reply message to data based on a chat message or sample data. The generative AI system 50 includes an interface that receives a chat message input by the user and sample data. The chat message and the sample data received by the interface is referred to as prompts. The prompts include sample data such as a file as well as the chat message (natural language) such as an instruction and a question. The chat message may be a conversational sentence or a word composed of a natural language spoken by a human. An image may also be the chat message. The generative AI system 50 that generates a sentence for data based on the chat message or the sample data may be referred to as a generative AI. In the present embodiment, the information processing system 20 uses a reply message that the generative AI system 50 replies to the data based on the sample data input by the user to generate an application that operates on the application service 40. The application that operates on the application service 40 includes a web application that operates on the application service 40 and a native application that is installed in the user terminal 10. When the native application installed in the user terminal 10 is executed in the user terminal 10, the native application is connected to the application service 40 and executes the function of the application service 40.

The generative AI system 50 has the following features. The generative AI system 50 performs a conversation in a natural flow. The generative AI system 50 can expand ideas even in a field in which the user does not have knowledge to propose. The generative AI system 50 can output accurate program code. Accordingly, the information processing system 20 can perform a conversation with the user through the generative AI system 50 in a natural flow. The user can only designate the application to be created to receive ideas necessary for the application. Since the function called by the generative AI system 50 is accurate (high reproducibility), the information processing system 20 easily generates the application desired by the user.

As the generative AI system 50, a system using LLM such as Generative Pre-trained Transformer-3 (GPT-3®), GPT-4®, Transformer®, or Bidirectional Encoder Representations from Transformers (BERT®) has been proposed. The application generation system 100 according to the present embodiment can use ChatGPT using GPT-3 or GPT-4. Alternatively, the application generation system 100 according to the present embodiment may use a system using another LLM.

The application service 40 is one or more information processing apparatuses that provide an application to be executed by a user. The application provided by the application service 40 is, for example, a database type web application that manages data in a table format. The user can set any fields of the application and can customize the application so that the user can store, read, or process data related to the customer's business. The development of the application is to set fields desired by the user in the database prepared in advance. In the present embodiment, the information processing system 20 includes the data based on the sample data from the user in a request message and transmits the request message to the generative AI system 50. The information processing system 20 generates or updates the application for the application service 40 using the response message from the generative AI system 50. In other words, the user can input the sample data to develop the application of the application service 40 with no code.

When the application service 40 and the information processing system 20 have different domains (e.g., when the service providers of the application service 40 and the information processing system 20 are different), the application service 40 and the information processing system 20 have different accounts even for the same user.

On the other hand, the application service 40 may be integral with the information processing system 20. In other words, the application service 40 may include the function of the information processing system 20. Alternatively, the information processing system 20 may include the function of the application service 40. The application service 40 may be integral with the generative AI system 50. The generative AI system 50 may be integral with the information processing system 20. The information processing system 20 may be integral with the application service 40 and the generative AI system 50.

The application service 40 is, for example, a cloud service, an application service provider (ASP), and a software as a service (SaaS), and may include various services provided via a network. The services provided via a network are, for example, a database provision service and a storage service. The application service 40 may reside on the Internet. Alternatively, the application service 40 may reside in an on-premises environment.

The information processing system 20 transmits the data based on the sample data transmitted from the user terminal 10 to the generative AI system 50. The information processing system 20 includes one or more information processing apparatuses. The information processing system 20 serves as a server that receives a request from the user terminal 10. The server is a computer or software that functions to provide information or a processing result in response to a request from the client. The information processing system 20 provides a user interface to the user terminal 10, generates a request message from the received sample data, and transmits the generated request message to the generative AI system 50. When the information processing system 20 receives an application generation request from the generative AI system 50, the information processing system 20 requests the application service 40 to generate an application. Accordingly, the user does not have to connect the user terminal 10 to the generative AI system 50 or the application service 40.

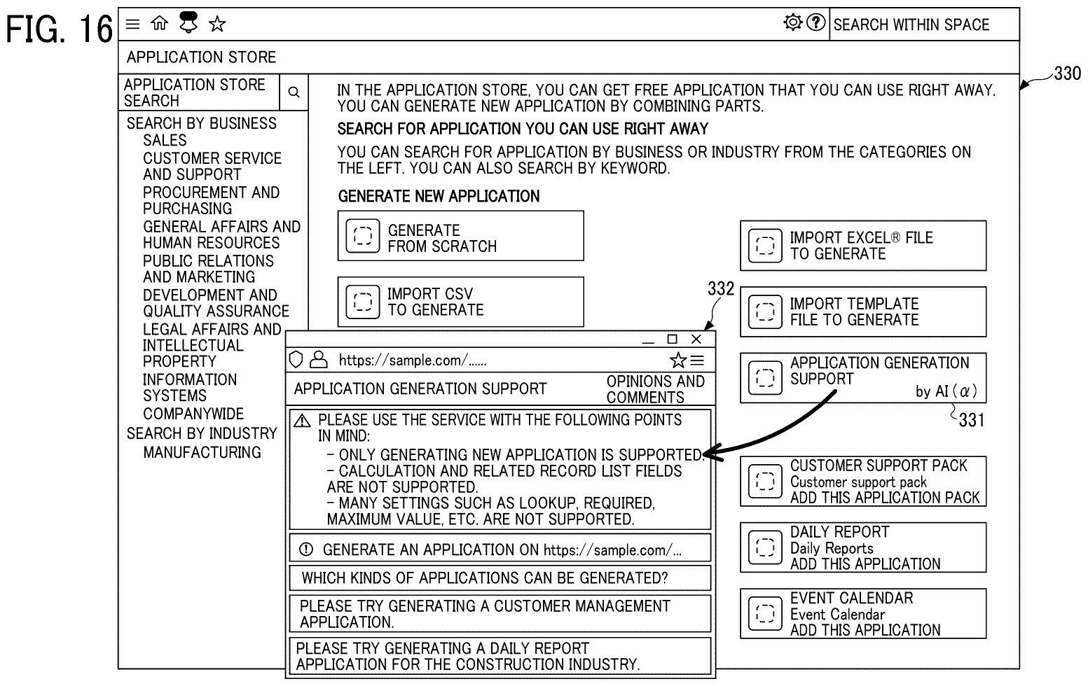

As described later, the user may develop an application using the application service 40 as a portal. The information processing system 20 receives a connection request to the generative AI system 50 from the user terminal 10 connected to the application service 40, and communicates with the generative AI system 50. A description is given of such communication with reference to FIGS. 16 to 18.

The information processing system 20 receives setting of setting information from the developer terminal 60. The setting of the setting information is to set knowledge (setting information) to be used for generating the application of the application service 40 in the information processing system 20. The setting information is information that the generative AI system 50 uses to generate the parameter of the application. The setting information may include, for example, what kind of application is requested to be generated. Since the developer sets the setting information in the information processing system 20, the user does not have to include the parameter of the application in the chat message or attach the parameter of the application to the sample data (the user can also attach the parameter of the application to the sample data). The information processing system 20 can create appropriate system setting related to the application to be generated based on the setting information and notify the generative AI system 50 of the created system setting. The system setting is generated from the setting information, and the system setting is part or all of the setting information.

The setting information is set in the information processing system 20 before the user starts developing the application. However, the information processing system 20 can customize the setting information for each customer. For example, when the setting information is “you will have a conversation with a customer of ABC business from now” according to the business type of the customer, the information processing system 20 changes the business type name of ABC according to the business type of the customer and notifies the generative AI system 50 of the business type name.

The information processing system 20 creates a request message to be transmitted to the generative AI system 50 using the setting information. In the request message, the setting information is reflected in the system setting described later. A detailed description is given later. The developer transmits the setting information to the information processing system 20, and thus the user can transmit the sample data to generate the application even if the user does not have technical knowledge of the application.

The setting of the setting information is not always be needed, and the setting information may not be needed depending on the application.

The information processing system 20 may be implemented by cloud computing. Alternatively, the information processing system 20 may be implemented by a single information processing apparatus. The “cloud computing” refers to a usage pattern in which resources on a network are used or accessed without identifying specific hardware resources. The information processing system 20 may reside on the Internet. Alternatively, the information processing system 20 may reside in an on-premises environment.

The information processing system 20 may have its functions distributed across multiple information processing apparatuses. Alternatively, the information processing system 20 may have the multiple information processing systems 20 with the same functions, and the number of the information processing system 20 may be increased or decreased depending on the processing load.

The user terminal 10 or the developer terminal 60 is, for example, a terminal device such as a personal computer (PC), a smartphone, or a tablet terminal used by the user or the developer. In the user terminal 10 or the developer terminal 60, a web browser or a native application operates. The developer operates the developer terminal 60 to generate setting information related to the application. The user operates the user terminal 10 to prepare sample data for developing the application of the application service 40. The sample data may be an existing form file. A detailed description is given later. An administrator or the user can operate the developer terminal 60 and the user terminal 10 to use various services provided by the information processing system 20, the generative AI system 50, or the application service 40.

The user terminal 10 may be any information processing apparatus. Such an information processing apparatus includes an output apparatus such as an electronic whiteboard or a digital signage. Such an information processing apparatus also includes a head up display (HUD) apparatus, an industrial machine, an imaging apparatus, a sound collecting apparatus, a medical apparatus, a network home appliance, a mobile phone, a smartphone, a tablet terminal, a game machine, a personal digital assistant (PDA), a digital camera, and a wearable PC.

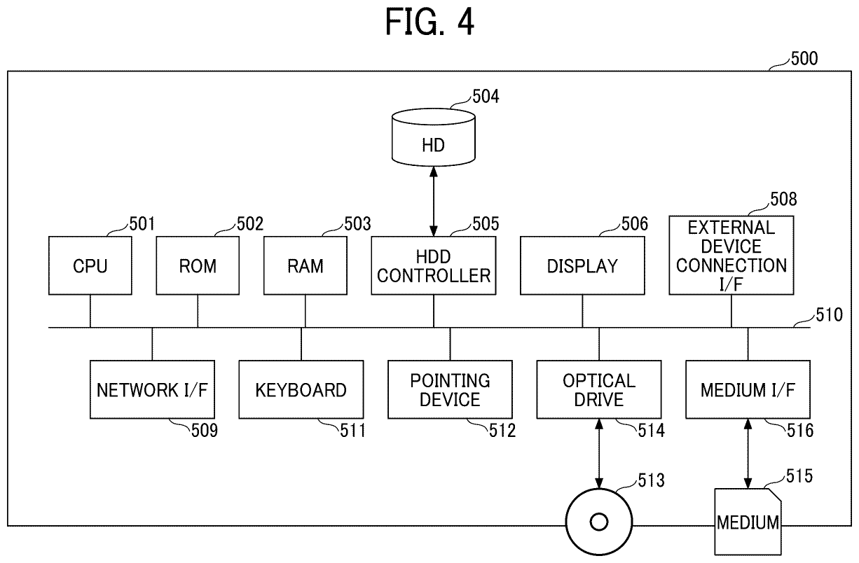

A description is given below of a hardware configuration of the information processing system 20, the user terminal 10, and the developer terminal 60 included in the application generation system 100 with reference to FIG. 4. The generative AI system 50 and the application service 40 have the same hardware configuration described in FIG. 4, or have a hardware configuration of an information processing apparatus compatible with cloud computing.

FIG. 4 is a diagram illustrating a hardware configuration of the information processing system 20, the user terminal 10, and the developer terminal 60 according to the present embodiment. As illustrated in FIG. 4, the information processing system 20, the user terminal 10, and the developer terminal 60 each are implemented by a computer 500. The computer 500 includes a central processing unit (CPU) 501, a read-only memory (ROM) 502, a random-access memory (RAM) 503, a hard disk (HD) 504, a hard disk drive (HDD) controller 505, a display 506, an external device connection interface (I/F) 508, a network I/F 509, a bus line 510, a keyboard 511, a pointing device 512, a digital versatile disk rewritable (DVD-RW) drive 514, and a medium I/F 516.

The CPU 501 controls the overall operation of the computer 500. The ROM 502 stores a program for controlling the CPU 501, such as an initial program loader (IPL). The RAM 503 is used as a work area for the CPU 501. The HD 504 stores various data such as a program. The HDD controller 505 controls the reading and writing of various data from and to the HD 504 under the control of the CPU 501. The display 506 displays various information such as a cursor, a menu, a window, a character, or an image. The external device connection I/F 508 is an interface for connecting the computer 500 to various external devices. In this case, the external devices include, but not limited to, a universal serial bus (USB) memory and a printer. The network I/F 509 is an interface for performing data communication using the network N2. The bus line 510 is, for example, an address bus or a data bus, which electrically connects the components illustrated in FIG. 4, such as the CPU 501.

The keyboard 511 is an input device (input means) including multiple keys used to input characters, numerals, or various instructions, for example. The pointing device 512 is an input device (input means) that allows the user to select or execute various instructions, select an item to be processed, or move a cursor being displayed. The DVD-RW drive 514 controls the reading and writing of various kinds of data from and to a DVD-RW 513, which serves as a removable recording medium. The removable recording medium is not limited to the DVD-RW 513, but a digital versatile disk recordable (DVD-R) may be used as the removable recording medium. The medium I/F 516 controls the reading or writing (storing) of data from or to a recording medium 515 such as a flash memory.

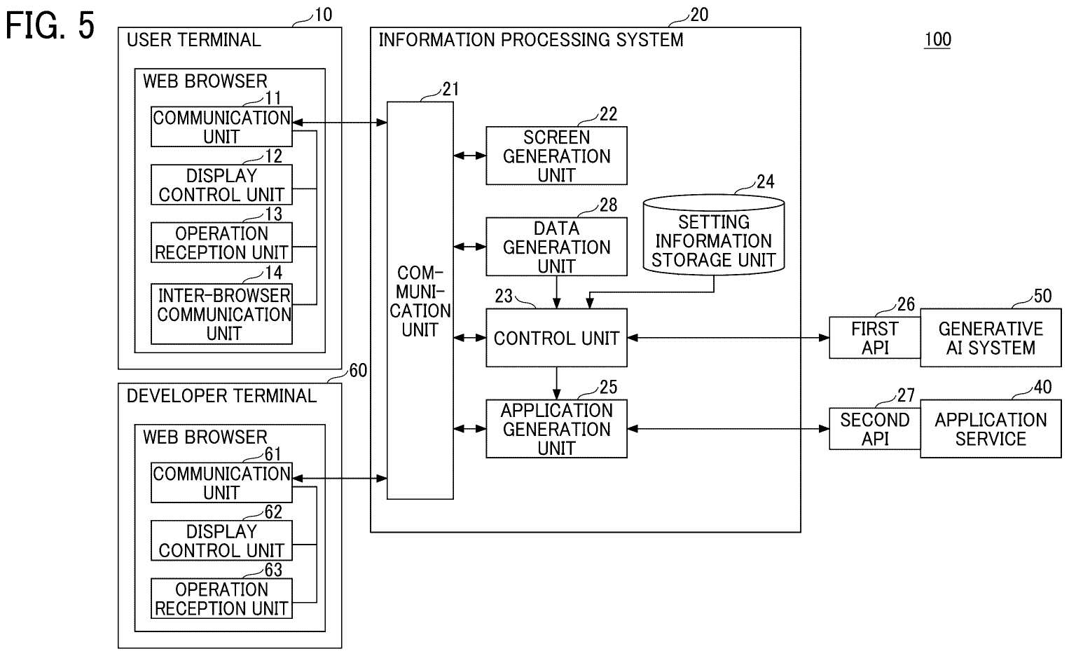

A description is given below of a functional configuration of the application generation system 100 with reference to FIG. 5. FIG. 5 is a diagram illustrating the functional configuration of the information processing system 20, the user terminal 10, and the developer terminal 60.

The user terminal 10 includes a communication unit 11, a display control unit 12, an operation reception unit 13, and an inter-browser communication unit 14. These functional units are functions or means that are implemented as the CPU 501 illustrated in FIG. 4 executes instructions included in one or more programs installed on the user terminal 10. For example, the communication unit 11, the display control unit 12, the operation reception unit 13, and the inter-browser communication unit 14 are implemented by one of or both of a web browser and a JavaScript® program. When the developer terminal 60 executes a native application, the communication unit 11, the display control unit 12, the operation reception unit 13, and the inter-browser communication unit 14 may be implemented by the native application.

The communication unit 11 transmits and receives various kinds of information to and from the information processing system 20. In the present embodiment, the communication unit 11 receives screen information of a portal screen from the application service 40, and receives screen information of an application generation page on which a chat message is input from the information processing system 20. The communication unit 11 transmits a chat message and operation information on the user terminal 10 to the information processing system 20. The communication unit 11 may directly communicate with the generative AI system 50.

The display control unit 12 interprets screen information of various screens to display screens on the display 506. The operation reception unit 13 receives various operations of the user on the various screens displayed on the display 506.

The inter-browser communication unit 14 transmits and receives information between the web browsers. One user terminal 10 can simultaneously execute multiple web browsers. The inter-browser communication unit 14 can notify information from one of the multiple web browsers to the other web browser (and vice versa). When only one of the web browsers includes authentication information for a specific web site (e.g., the application service 40), the inter-browser communication unit 14 enables the other web browser to communicate with the specific web site in cooperation with the one web browser. It is assumed that one of the web browsers communicates with the application service 40 and the other web browser communicates with the generative AI system 50 via the information processing system 20. The other web browser can transmit the response message from the generative AI system 50 to the one web browser. The function of the inter-browser communication unit 14 is executed by the web browser (user terminal 10), and is written in JavaScript® to implement the inter-browser communication unit 14 in the screen information transmitted from the application service 40 and the information processing system 20.

The developer terminal 60 includes a communication unit 61, a display control unit 62, and an operation reception unit 63. These functional units are functions or means implemented by the CPU 501 illustrated in FIG. 4 executing commands included in one or more programs installed in the developer terminals 60. For example, the communication unit 61, the display control unit 62, and the operation reception unit 63 may be implemented by at least one of the web browsers and the JavaScript® programs. Alternatively, the communication unit 61, the display control unit 62, and the operation reception unit 63 may be implemented by the native application when the developer terminal 60 executes a native application.

The communication unit 61 transmits and receives various kinds of information to and from the information processing system 20. In the present embodiment, the communication unit 61 receives screen information regarding input of setting information from the information processing system 20. The communication unit 61 transmits the setting information and operation information for the developer terminal 60 to the information processing system 20. The communication unit 21 can also communicate with the generative AI system 50 and the application service 40.

The display control unit 62 interprets screen information of various screens to display screens on the display 506. The operation reception unit 63 receives various operations of the user on the various screens displayed on the display 506.

The information processing system 20 includes a communication unit 21, a screen generation unit 22, a control unit 23, a setting information storage unit 24, an application generation unit 25, and a data generation unit 28. The functional units of the information processing system 20 are functions or means implemented by the CPU 501 illustrated in FIG. 4 executing commands included in one or more programs installed in the information processing system 20. The setting information storage unit 24 is implemented in the HD 504 or the RAM 503 illustrated in FIG. 4. The setting information storage unit 24 may not be included in the information processing system 20, and may be provided on a network that can be accessed by the information processing system 20.

The communication unit 21 transmits and receives various kinds of information to and from the user terminal 10. The communication unit 21 transmits screen information of the application generation page to the user terminal 10. The communication unit 21 receives chat messages and sample data input by the user for application development from the user terminal 10. The communication unit 21 transmits and receives various kinds of information to and from the developer terminal 60. The communication unit 11 transmits screen information of an input screen of setting information to the developer terminal 60. The communication unit 11 receives the setting information input by the developer from the developer terminal 60 and stores the setting information in the setting information storage unit 24.

The screen generation unit 22 generates screen information of a screen (web page) displayed by the user terminal 10 and the developer terminal 60. The web page is provided as a part of the web application. The screen information is a program written in, for example, hypertext markup language (HTML), JavaScript® object notation (JSON), extensible markup language (XML), a script language, and a cascading style sheet (CSS). The structure of the web page is specified by HTML, the operation of the web page is defined by the script language, and the style of the web page is specified by the CSS. The user terminal 10 may execute a native application. The native application is an application that cannot be executed unless the application is installed in the user terminal 10. In the case of a native application, the user terminal 10 includes the screen information, and the information to be displayed is transmitted in JSON or XML.

The data generation unit 28 converts the sample data received by the communication unit 21 into a predetermined format to generate data (data based on the sample data) acquired. The data generation unit 28 passes the converted data to the control unit 23. When the data based on the sample data received by the communication unit 21 is the same data as the sample data (in the case of sample data without conversion), the data generation unit 28 does not perform the conversion.

The control unit 23 calls a first API 26 to transmit a request message to the generative AI system 50. The request message includes sample data information and a function specification setting. The sample data information includes data based on the sample data generated by the data generation unit 28. The control unit 23 can also transmit a request message including the chat message (including a history of past conversations) input by the user to the generative AI system 50 before or after the sample data information is transmitted or together with the sample data information.

The first API 26 is one or more APIs published by the generative AI system 50. As a result of calling the first API 26, the control unit 23 receives a response message to the request message from the generative AI system 50. The response message includes a reply message to the chat message, a function call request to the information processing system 20, or a URL of a generated or developed application.

The application generation unit 25 calls a second API 27 to transmit a request message to the application service 40. The application generation unit 25 functions by executing a function defined in advance. The request message includes parameters such as a field name of a database and a data format related to the application. The request message to the application service 40 is for requesting generation or update of the application. The second API 27 is one or more APIs published by the application service 40. As a result of calling the second API 27, the application generation unit 25 receives a response message to the request message from the application service 40. The response message includes a result (success or failure) of the request for generation or update of the application. When the generation or update of the application is successful, the URL of the application is notified, and when the generation or update of the application is failure, an error message is notified.

The application generation unit 25 may generate an application in the information processing system 20 without requesting the application service 40. The application generation unit 25 may generate, for example, a macro that operates on spreadsheet software. Alternatively, the application generation unit 25 may set a field in database software.

Generating the application by the application generation unit 25 includes not only that the application generation unit 25 actually generates the application, but also that the application generation unit 25 requests the application service 40 to generate the application and then the application service 40 actually generates the application.

In the present embodiment, the information processing system 20 calls the first API 26 published by the generative AI system 50 to use the generative AI system 50. The information processing system 20 can call the first API 26 to have a conversation with the AI which is one of the functions of the generative AI system 50. The generative AI system 50 has characteristic operations or processes, and thus, a supplementary description is given below.

The information processing system 20 transmits a request message for calling the API to the generative AI system 50 to communicate with the generative AI system 50. The information processing system 20 can acquire the response message from the generative AI system 50 using the request message enables.

The generative AI system 50 returns a response message to the request message to the information processing system 20. The reply message included in the response message of the generative AI system 50 is often different even if the chat message input by the user is the same. However, when the information processing system 20 designates a parameter called temperature as zero, the generative AI system 50 returns the same reply message in response to the same chat message.

When the information processing system 20 wants to continue the conversation with the generative AI system 50, each history of past conversations is included in the request message. This is because the conversation with the generative AI system 50 is stateless. This is a specification of one generative AI system 50, and another generative AI system 50 may not include a history of past conversations.

As described above, the first API 26 does not have any state regarding past communications (stateless). Accordingly, the user of the first API 26 (in the present embodiment, the information processing system 20 is the user) needs to include the history of past conversations and specifies the history the past conversations each time when the first API 26 is called. The history of past conversations may be included by the user terminal 10. When the history of past conversations is too long, the first API 26 returns an error. Accordingly, it is preferable that the information processing system 20 appropriately contrive the way to include the history of past conversations. For example, the information processing system 20 includes only the latest conversation in the request message when the conversations continue for a long time.

The functions provided by the generative AI system 50 include the function called function call. The function call indicates that the generative AI system 50 requests the information processing system 20 to call a function. Accordingly, when the information processing system 20 causes the generative AI system 50 to use this function, the generative AI system 50 can call the “function”.

The request message includes function specification setting set by the information processing system 20 so that the generative AI system 50 calls the “function”. The function specification setting enables the generative AI system 50 to perform a function call (function call request). As described above, the function specification setting is information on the first API 26 for calling the application generation unit 25. In other words, in the function specification setting, the information processing system 20 notifies the generative AI system 50 that the generative AI system 50 can request the information processing system 20 to call a function.

In this way, the information processing system 20 causes the generative AI system 50 to use the function call, and thus the generative AI system 50 calls the function provided by the information processing system 20, and the information processing system 20 can execute the function. The information processing system 20 can use the execution result of the function to have a conversation with the user.

However, since the response message of the generative AI system 50 is different each time, the generative AI system 50 may not make a function call request. Even if the information processing system 20 includes the function specification setting in the request message, the generative AI system 50 may return the same response message as that in the case where the function specification setting is not included.

When the process of including each history of past conversations in the request message is employed, it is necessary to include the execution result of the function executed by the information processing system 20 in the request message and transmit the request message to the generative AI system 50. However, the information processing system 20 may not include the execution result of the function in the request message and transmit the request message to the generative AI system 50 together with the history of past conversations. In other words, the information processing system 20 may transmit the execution result of the function to the user terminal 10 as it is. However, when the information processing system 20 transmits the execution result of the function to the generative AI system 50, the generative AI system 50 can continue the conversation using the history of past conversations, and thus, continuity is created in the conversation. For example, consistency is generated in the style of writing and wording, and thus the user is less likely to feel any sense of discomfort. For example, even if the user's native language is English and the user has a conversation in English, the information processing system 20 does not need to translate the reply message into English.

The information processing system 20 cannot predict whether the generative AI system 50 will request a function call. However, when the information processing system 20 explicitly designates the function call in the request message, the information processing system 20 can force the generative AI system 50 to call the function.

In the present embodiment, a description is given below of a request message transmitted by the information processing system 20 and a response message transmitted by the generative AI system 50 in a case where the user develops an estimate management application.

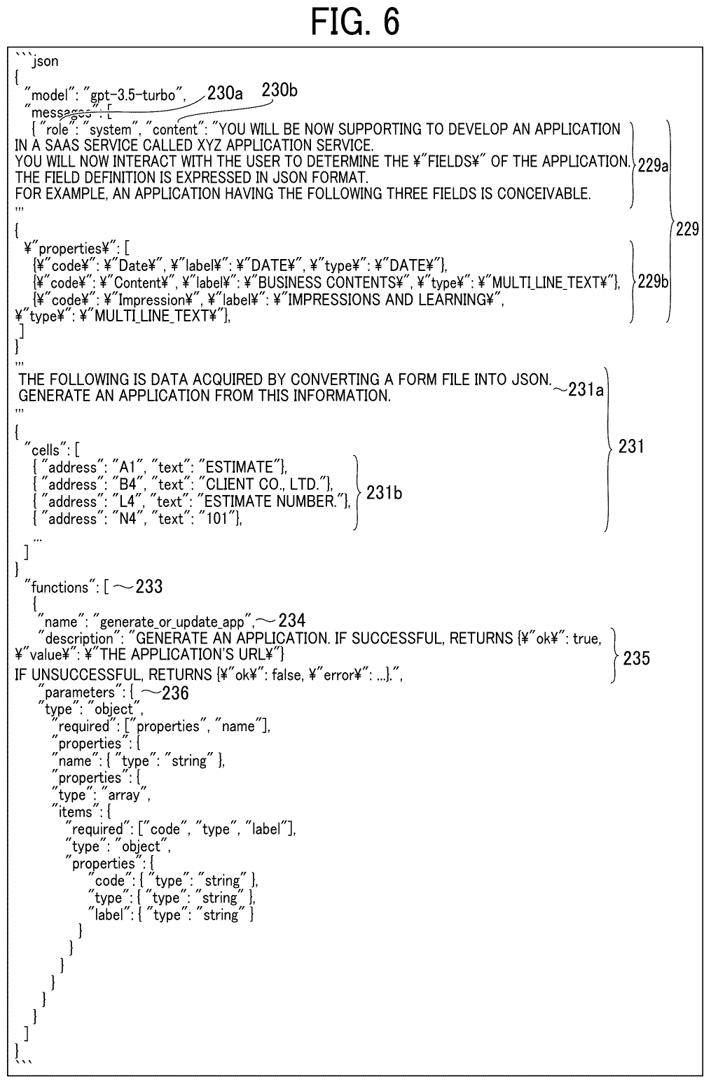

FIG. 6 is a diagram illustrating a request message that the information processing system 20 uses to call the API of a generative AI system 50 when the user operates the user terminal 10 to transmit sample data to the information processing system. The request message of FIG. 6 includes a system setting 229 by a system. The system setting 229 includes information 229a that contains a message “You will be now supporting to develop an application in a SaaS service called XYZ application service. You will now interact with the user to determine the “fields” of the application. The field definition is expressed in JSON format. For example, an application having the following three fields is conceivable.” The system setting 229 also includes information 229b indicating fields “date”, “business content”, and “impressions and learning” as field names. The data format is also indicated for each field, the “date”, the “business content”, and the “impressions and learning”, as DATE, MULTI_LINE_TEXT, and MULTI_LINE_TEXT, respectively. The information 229a and the information 229b are based on the setting information transmitted to the information processing system 20 by the developer in advance.

The information 229a includes a role 230a and a content 230b. The role 230a indicates a speaker, and the speaker can be a user, an assistant (AI of the generative AI system 50), and a system (instructing setting of AI assistant). The content 230b is the content of the speech and may be described in a natural language.

The request message includes sample data information 231 transmitted from the user terminal 10. The sample data information 231 includes a message 231a that contains “The following is data acquired by converting a form file into JSON. Generate an application from this information.” The control unit 23 generates the message 231a based on an application generation request designating the sample data from the user terminal 10.

The sample data transmitted from the user terminal 10 to the generative AI system 50 is often in a file format. Accordingly, when the generative AI system 50 does not support the sample data in the file format, the data generation unit 28 converts the data included in the file into a format supported by the generative AI system 50. In FIG. 6, each item included in the sample file (e.g., a form file) transmitted from the user terminal 10 is converted into data 231b in the JSON format. The data 231b corresponds to “data based on the sample data”. The data 231b transmitted to the generative AI system 50 may be in an XML format, a comma separated values (CSV) format, or a text format. When the generative AI system 50 supports the file format, the data 231b transmitted to the generative AI system 50 may be in the file format. The file format may be Microsoft® Excel, Microsoft® Word, Microsoft® PowerPoint, or portable document format (PDF), as long as the generative AI system 50 supports.

In the present embodiment, for convenience of description, the sample data transmitted from the user terminal 10 and the sample data information 231 (the data format of the sample data information 231 may be converted) transmitted to the generative AI system 50 may be referred to as “sample data” without distinction.

The request message of FIG. 6 includes a function specification setting 233. A “functions” illustrated in FIG. 6 is the function specification setting 233, and the function specification setting 233 includes the following attributes. A name 234 illustrated in FIG. 6 is the name of the function (the name of the function is generate_or_update_app). A description 235 illustrated in FIG. 6 indicates the specification of the function. The detail of the specification is “description”: “An application is generated. If successful, returns {¥″ok¥″: true, ¥″value¥″: ¥″ the application's URL¥″} if unsuccessful, returns {¥″ok¥″: false, ¥″error¥″: . . . }.” In other words, the description 235 instructs the generative AI system 50 to return a URL or an error message. A parameters 236 illustrated in FIG. 6 is also part of the specification of the function. A ““type”: “object”” illustrated in FIG. 6 indicates the data format of the return value of the function. A ““required”: [“properties”, “name”]” illustrated in FIG. 6 indicates an item name desired for the return value. A “name”: {“type”: “string”}” illustrated in FIG. 6 indicates the data format of the “name” described in the “required” described above. A ““type”: “array”” illustrated in FIG. 6 indicates that the data is in a table format.

An “items” illustrated under the ““type”: “array”” in FIG. 6 and the following items indicate the attributes and data formats required for the fields.

The information processing system 20 instructs the generative AI system 50 that the generative AI system 50 can request the information processing system 20 to call the function defined as illustrated in FIG. 6 using the function specification setting 233.

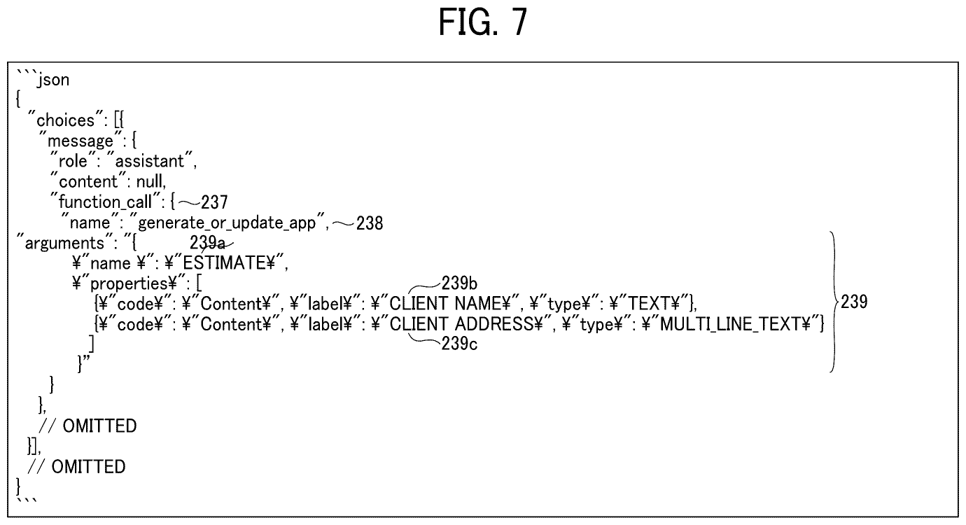

FIG. 7 is a diagram illustrating a response message of the generative AI system 50 in response to the request message of FIG. 6. The response message includes a function call request 237. In the present embodiment, when the function call is included in the response message, the information processing system 20 generates an application of the application service 40. The application service 40 is a no-code platform or low-code platform. The application of the application service 40 is a database for managing user data, and the user can easily customize a UI screen for displaying data. The application service 40 discloses various APIs, and the information processing system 20 can call the second API 27 to generate and update the application. In the present embodiment, the information processing system 20 calls the second API 27 published by the application service 40 and the first API 26 published by the generative AI system 50, and thus, the information processing system 20 can generate or update the application of the application service 40.

The function call request 237 of the response message corresponds to an application generation request. The function call request 237 includes a name 238 and arguments 239. The name 238 illustrated in FIG. 7 is the name of the function defined in the function specification setting 233 of FIG. 6. The generative AI system 50 requests a call to a function with this name. The arguments 239 are return value, and are defined in the function specification setting 233. In FIG. 7, the arguments 239 includes an application name 239a, which is “estimate”, a field name 239b and a field name 239c included in the estimate management application, identification information (“Content” of item “code”) included in the field name 239b, and a data format (“TEXT” or “MULTI_LINE_TEXT” of item “type”) included in the field name 239c.

For example, the application name 239a, the field name 239b, and the field name 239c are application name and field names determined by the generative AI system 50 based on the sample data information 231, and may or may not be included in the sample data information 231. When the application name 239a, the field name 239b, and the field name 239c are not included in the sample data information 231, it is inferred that the generative AI system 50 has generated the application name 239a, the field name 239b, and the field name 239c that are not included in the sample data information 231 from system settings, function specification settings, and other learned information.

The generative AI system 50 can specify a field name such as business contents by the function call and request the information processing system 20 to call a function for generating the application.

The information processing system 20 analyzes the function call included in the response message to determine whether to generate and update the application of the application service 40 (execution of the function). When the information processing system 20 determines to generate and update the application of the application service 40, the information processing system 20 calls the second API 27 published by the application service 40, and uses the field name or the data format (an example of the parameter) included in the response message to generate or update the application. When the application is successfully generated or updated, the information processing system 20 acquires the URL of the application from the application service 40. The URL is access information for the user terminal 10 to access the application. The information processing system 20 returns the URL of the application to the generative AI system 50. Accordingly, continuity is created in the conversation between the user and the generative AI system 50.

Specifically, the information processing system 20 uses three APIs of the application service 40 as described below. The three APIs are a first API for generating application to be published by the application service 40, a second API for adding two fields, “date” and “business contents,” to the application generated by the first API, and a third API for publishing the application. When the generation or update of the application is successful, the information processing system 20 designates the result of the function (the URL of the application) and calls the first API 26 published by the generative AI system 50 again.

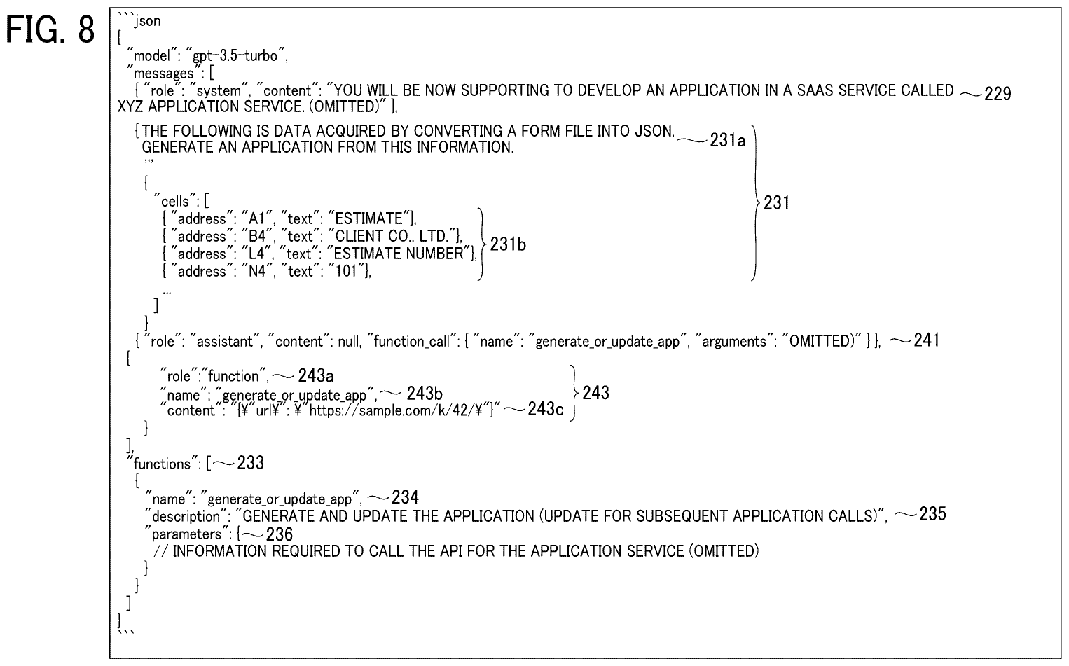

FIG. 8 is a diagram illustrating a request message transmitted to the generative AI system 50 after the information processing system 20 generates or updates the application for the application service 40. The request message includes the system setting 229, the sample data information 231, and a function call request 241 as a history of past conversations. The information processing system 20 adds a function execution result 243 to the history of past conversations. The function execution result 243 in FIG. 8 includes a flag 243a indicating that the function has been executed, a name 243b indicating the name of the function that has been executed (generate_or_update_app), and a URL 243c indicating the URL of the function that has been executed. The function specification setting 233, which is illustrated in FIG. 6, is illustrated in FIG. 8 again and is also the history of past conversations. Although the function specification setting 233 is included as the history of past conversations in FIG. 8, the function specification setting 233 may not be included depending on the specification of the API provided by the generative AI system 50.

Although the history of past conversations (the system setting 229, the sample data information 231, the function call request 241, the flag 243a indicating the execution of the function, and the name 243b indicating the name of the function) is included in addition to the URL 243c in FIG. 8, the information processing system 20 may transmit only the URL 243c to the generative AI system 50 when the generative AI system 50 has a capability of storing the history of past conversations. In other words, the information processing system 20 may transmit the content of the history of past conversations to the generative AI system 50 at least once in the past.

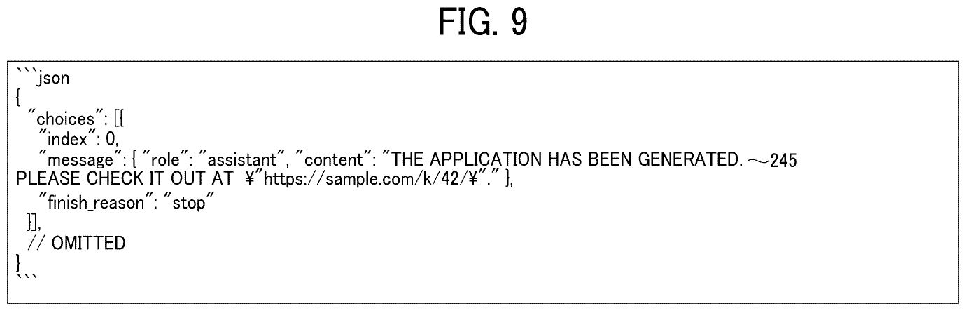

FIG. 9 is a diagram illustrating an example of a response message of the generative AI system 50 in response to the request message of FIG. 8. In the case of application development, the response message is often different each time. For example, it is expected that the response message as illustrated in FIG. 9 is returned. The response message of FIG. 9 includes a reply message 245. The content of the reply message 245 is “The application has been generated. Please check it out at https://sample.com/k/42/.” The information processing system 20 transmits the URL included in the reply message 245 to the user terminal 10, and thus the user can press the URL to confirm the field name of the developed application (database).

Inputting of a chat message (e.g., an instruction to modify the application) and transmission and reception of the request message and the response message between the information processing system 20 and the generative AI system 50 are repeated until the user is satisfied. As described above, since the user can transmit the sample data or make a conversation to develop the application of the application service 40, the user does not need any programming knowledge.

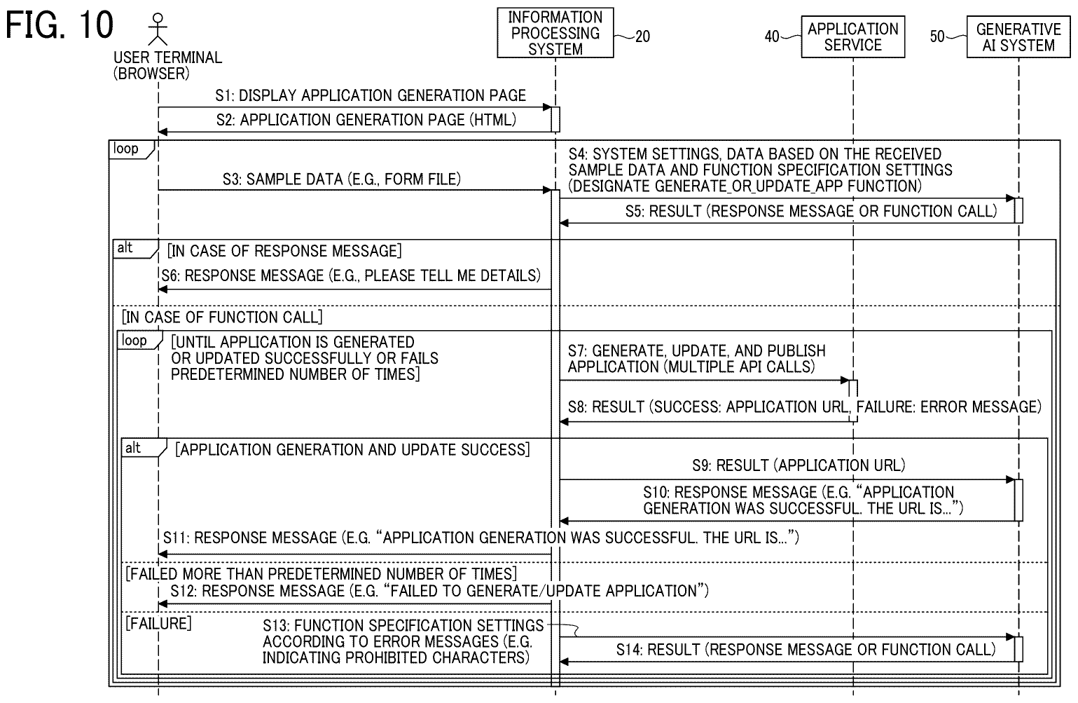

FIG. 10 is a sequence diagram illustrating processing of supporting application development by the information processing system 20. As a large processing flow, steps S3 to S14 are repeatedly executed, and within the steps S3 to S14, steps S9 to S14 are repeatedly executed.

In step S1, the communication unit 11 of the user terminal 10 connects to the URL of the information processing system 20. The URL may be designated by a method in which the user directly inputs the URL in the user terminal 10 or by executing a shortcut in which the URL is designated. The communication unit 11 of the user terminal 10 generates an HTTP request including the URL of the application generation page and transmits the generated HTTP request to the information processing system 20.

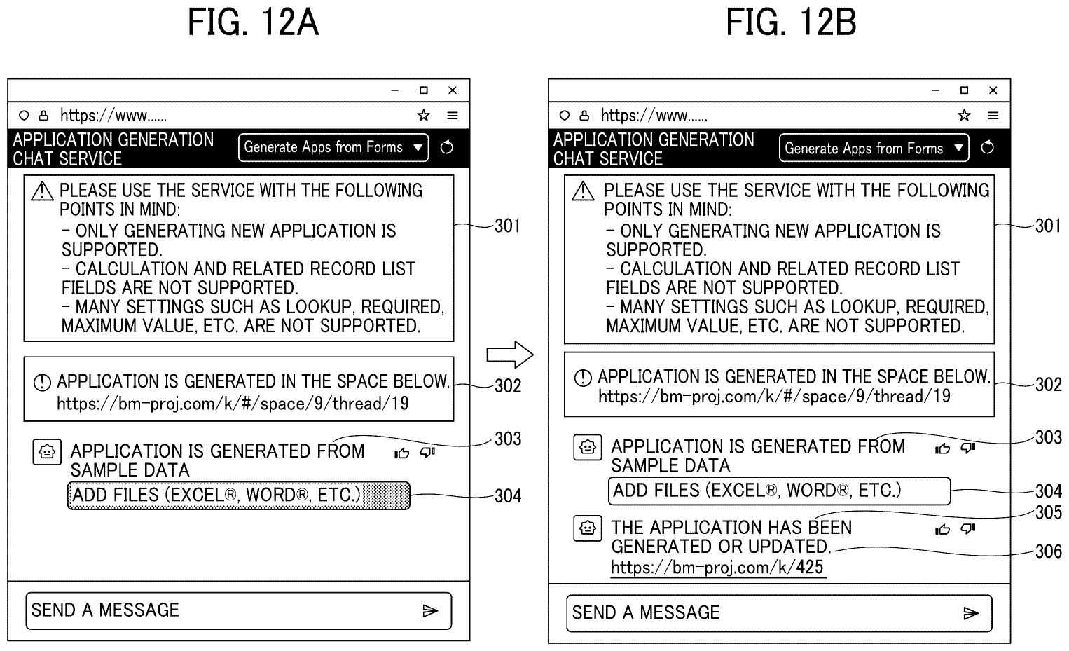

In step S2, when the communication unit 21 of the information processing system 20 receives the HTTP request from the user terminal 10, the screen generation unit 22 creates screen information of the application generation page. The communication unit 21 transmits an HTTP response including screen information of the application generation page to the user terminal 10 as a response to the HTTP request. FIGS. 12A and 12B are diagrams illustrating the application generation page.

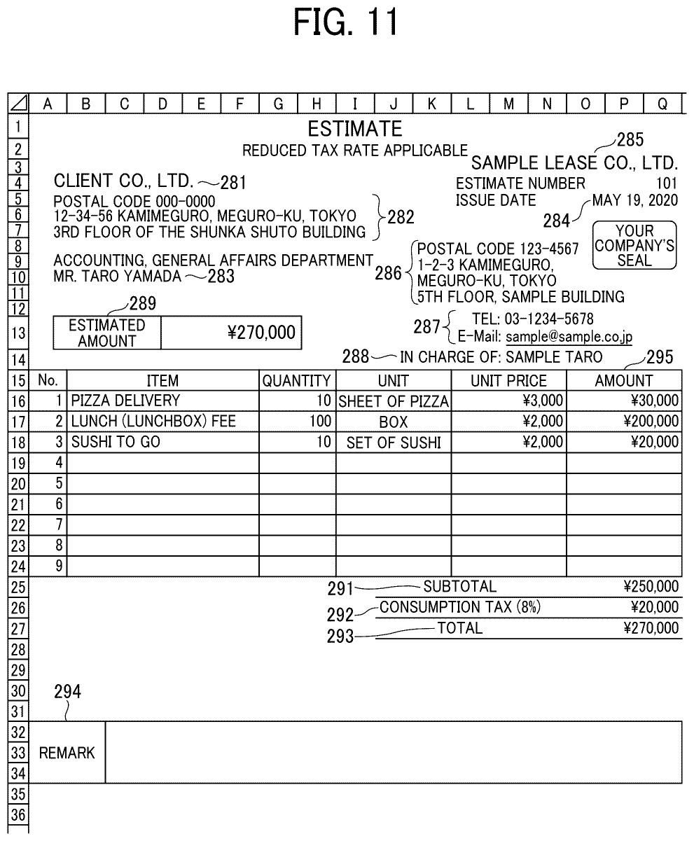

In step S3, the user operates the user terminal 10 to select sample data (e.g., a form file such as an estimate). The sample data (see FIG. 11) may include an item to be input to an application to be generated. The input may be performed using a keyboard or by voice. The operation reception unit 13 receives the designation of the sample data. The communication unit 11 of the user terminal 10 generates a request message including the sample data and transmits the generated request message to the information processing system 20. The communication unit 11 of the user terminal 10 transmits the generated request message as, for example, an HTTP request. The communication unit 11 of the user terminal 10 may generate the request message including a history of past conversations. The information processing system 20 may store the history of the past conversation. When the information processing system 20 stores the history of past conversations, the communication unit 11 of the user terminal 10 may not include the history of the past conversations in the request message.

In step S4, the communication unit 21 of the information processing system 20 receives the sample data. The communication unit 21 of the information processing system 20 passes the sample data information 231 to the data generation unit 28 and the control unit 23. The data generation unit 28 converts the sample data into the data 231b based on the sample data and passes the data 231b to the control unit 23. The control unit 23 generates a request message including the system setting (setting information), the sample data information 231 (the data 231b based on the sample data in FIG. 10), and the function specification setting, and calls the first API 26 (see FIG. 6) to transmit the generated request message to the generative AI system 50. In the present embodiment, the sample data information 231 transmitted in step S4 includes the data 231b based on the sample data converted into a format supported by the generative AI system 50. However, the sample data information 231 transmitted in step S4 may be in the file format.

In step S5, the generative AI system 50 returns a reply message or a response message including a function call request to the information processing system 20 (see FIG. 7). The control unit 23 receives the response message from the generative AI system 50. The response message that the control unit 23 receives may be a reply message or a function call request. In the case of the function call request, the process proceeds to step S7, and in the case of the reply message, the process proceeds to step S6.

In step S6, when the control unit 23 receives the normal reply message, the communication unit 21 of the information processing system 20 transmits the reply message to the user terminal 10. For example, the reply message is “Please tell me details.”

In step S7, when the control unit 23 receives the function call request, the control unit 23 analyzes the function included in the function call request and determines that the generation or update of the application of the application service 40 is requested (application generation request). Since the function for generating the application is designated in the function specification setting 233 of step S4, the control unit 23 can easily determine that the request is the application generation request based on the name (the name 238) of the function included in the function call request. The control unit 23 also acquires the arguments 239 (the application name 239a, the field name 239b, the field name 239c, and a data format) included in the function call request.

The control unit 23 requests the application generation unit 25 to generate or update the application of the application service 40. The application generation unit 25 calls the second API 27 to transmit a request message for generating or updating the application to the application service 40. In other words, the application generation unit 25 transmits the request message to implement the function of the function call request from the generative AI system 50. In the present embodiment, the application generation unit 25 generates or updates the application. The application generation unit 25 calls the three APIs described above. The three APIs are the first API for generating application to be published by application service 40, the second API for adding two fields, “date” and “business contents”, to the application generated by the first API, and the third API for publishing the application. In the second API, the application generation unit 25 requests generation of the application, including arguments 239 (the application name 239a, the field name 239b, the field name 239c, and the data format), which are parameters included in the response message from the generative AI system 50, in the request message. The specific request message may vary depending on the application service 40.

The information processing system 20 updates the existing application at the time of the second function call request. In other words, not only the generation of the application but also the update of the application can be performed.

In step S8, the application generation unit 25 receives a response message from the application service 40. The result included in the response message is, for example, “a URL of application.” When the generation of the application is failed, an error message is returned from the application service 40. When the generation of the application is successful, the process proceeds to step S9. When the generation of the application is failed, the process proceeds to step S13.

In step S9, when the application is successfully generated, the control unit 23 calls the first API 26 to transmit a request message including the URL of the application to the generative AI system 50 (see FIG. 8). Accordingly, continuity is created in the conversation between the user and the generative AI system 50.

In step S10, the generative AI system 50 returns a response message including a reply message to the information processing system 20. The control unit 23 receives the response message from the generative AI system 50 (see FIG. 9). The response message includes the URL of the application.

In step S11, when the application is successfully generated, the communication unit 21 of the information processing system 20 transmits the reply message included in the response message of step S10 to the user terminal 10. The process of FIG. 10 is ended, and after that, the user returns to step S3 as needed in order to update the application. In this case, the user designates other sample data or instructs the modification of the application by a chat message.

In step S12, when the application is failed for a predetermined number of times or more, the communication unit 21 of the information processing system 20 transmits a result such as “Failed to generate/update application” to the user terminal 10. The process of FIG. 10 is ended, and after that, the user returns to step S3 as needed in order to generate an application again. In this case, the user designates other sample data.

In step S13, when the response message of the step S8 is to notify the failure of the application generation, the control unit 23 calls the first API 26 to transmit the error message from the application service 40 to the generative AI system 50. In addition to the error message, the control unit 23 also transmits the sample data information 231. Accordingly, the generative AI system 50 can create a function call request that does not output an error message. For example, when the request message transmitted from the application generation unit 25 to the application service 40 violates the specifications of the second API 27 published by the application service 40, the error message may include the contents of the correct specifications. The generative AI system 50 understands the specifications and can approach the function call request without an error message. For example, when the error message indicates a character type that cannot be used in the application service 40, the error message includes the character type that cannot be used, and thus the generative AI system 50 can create a function call request that does not include the character type. The request message is not limited to the character type, and the same applies to the format of the request message.

In step S14, the control unit 23 receives the response message from the generative AI system 50. The response message is a function call request or a reply message. However, since the control unit 23 has transmitted the error message, it is expected that the response message includes a function call request for successfully generating an application. In the case of the function call request, the process proceeds to step S7, and in the case of the reply message, the process proceeds to step S6.

FIG. 11 is a diagram illustrating the sample data that the user uses as input to the generative AI system 50. The user may select sample data in a file format, and does not need to display the content of the file on the user terminal 10. The sample data in FIG. 11 is an estimate in a form. The sample data includes a client name 281, an address 282, a person in charge name 283, and an estimated amount 289. The sample data also includes column headings 295 (no, item, quantity, unit, unit price, and amount). The number of records is three. The sample data includes an estimate issuing company 285, an estimate issue date 284, an estimate issuing company address 286, an estimate issuing company contact information 287, and an estimate issuing company person in charge 288. The sample data includes items of a subtotal 291, a consumption tax 292, a total 293, and a remark 294.

In the present embodiment, a form file is described as an example. However, the sample data may be any data appropriate for the application generated by the application service 40. For example, when the application to be generated is a business card management application, the sample data is business card data, and when the application to be generated is a cost management application, the sample data is a receipt. When the application to be generated is a human resource management application, the sample data is personal data, and when the application to be generated is a questionnaire management application, the sample data is questionnaire data.

FIGS. 12A and 12B are diagrams illustrating an application generation page displayed by the user terminal 10. The description given in reference to FIG. 12A mainly includes the differences from FIG. 2A. When the user presses the adding button 304, a file list screen is displayed, and the user can select sample data to be transmitted to the generative AI system 50. The user terminal 10 transmits the sample data of FIG. 11 to the information processing system 20, and the information processing system 20 transmits a request message including the sample data information 231 and the specification of the function to the generative AI system 50. Accordingly, the generative AI system 50 transmits a function call request (function call) to the information processing system 20, and the information processing system 20 can generate an application for the application service 40 (execution of function).

FIG. 12B is a diagram illustrating an application generation support screen displayed by the user terminal 10 in response to a reply message indicating that the information processing system 20 has generated the application. In other words, the state of FIG. 12B is changed from the state of FIG. 12A. On the application generation support screen of FIG. 12B, a reply message 305, which is “The application has been generated or updated.”, and a URL 306 where the application is generated are displayed.

The user can press the URL 306 with a mouse pointer to use the generated or updated application. As a result, the user can develop the estimate management application without any knowledge of programming or even knowledge of the estimate management application.

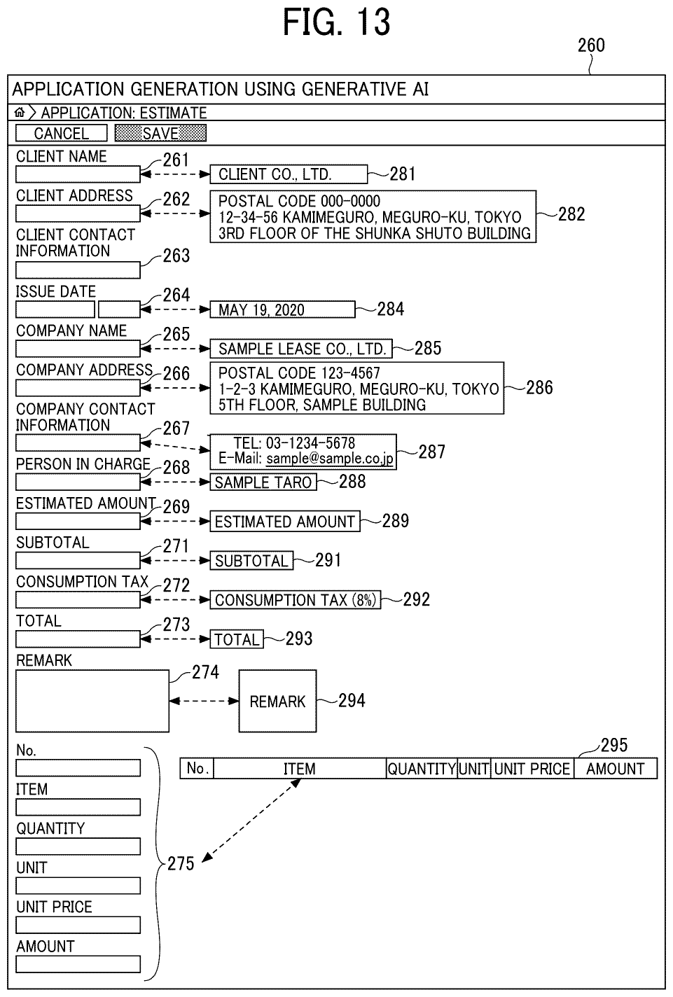

FIG. 13 is a diagram illustrating the estimate management application screen 260 displayed by the estimate management application when the URL 306 where the estimate management application is generated is pressed. For the sake of convenience, the estimate management application screen 260 includes descriptions corresponding to the estimate in FIG. 11, but the descriptions are not displayed in practice. The estimate management application screen 260 includes fields of a client name 261, a client address 262, a client contact information 263, an issue date 264, a company name 265, a company address 266, a company contact information 267, a person in charge 268, an estimated amount 269, a subtotal 271, a consumption tax 272, a total 273, and remark 274. The estimate management application screen 260 includes a column heading list 275.

The client name 261 is presumed to have been generated based on the client name 281 of the estimate in FIG. 11.

The client address 262 is presumed to have been generated based on the address 282 of the estimate in FIG. 11.

The client contact information 263 is presumed to have been originally generated by the generative AI system 50.

The issue date 264 is presumed to have been generated based on the estimate issue date 284 of the estimate in FIG. 11.

The company name 265 is presumed to have been generated based on the estimate issuing company 285 of the estimate of FIG. 11.

The company address 266 is presumed to have been generated based on the estimate issuing company address 286 of the estimate of FIG. 11.

The company contact information 267 is presumed to have been generated based on the estimate issuing company contact information 287 of the estimate of FIG. 11.

The person in charge 268 is presumed to have been generated based on the estimate issuing company person in charge 288 of the estimate of FIG. 11.

The estimated amount 269 is presumed to have been generated based on the estimated amount 289 of the estimate sheet in FIG. 11.

The subtotal 271 is presumed to have been generated based on the subtotal 291 of the estimate of FIG. 11.

The consumption tax 272 is presumed to have been generated based on the consumption tax 292 of the estimate of FIG. 11.

The total 273 is presumed to have been generated based on the total 293 of the estimate of FIG. 11.

The remark 274 is presumed to have been generated based on the remark 294 of the estimate of FIG. 11.

The column heading list 275 is presumed to have been generated based on the column headings 295 of the estimate in FIG. 11.

These fields are generated by the user terminal 10 transmitting the sample data to the information processing system 20. Accordingly, the user can develop the estimate management application without listing any field name.

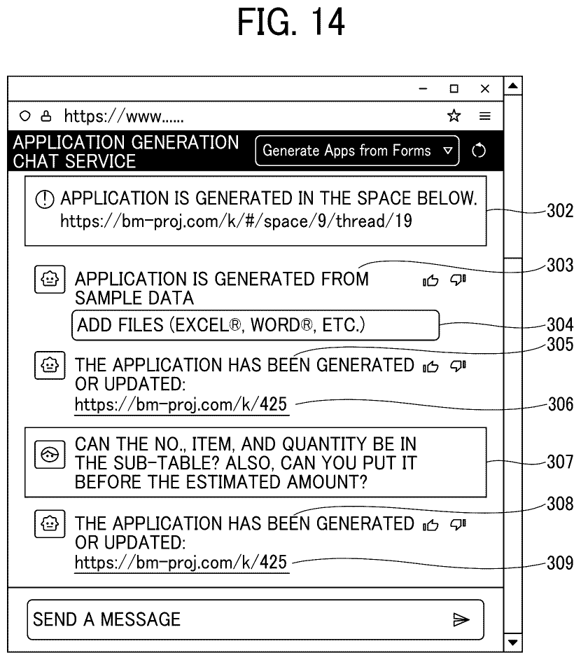

A description is given below of a display of an application generation page displayed by the user terminal 10 when the user modifies the generated application with reference to FIG. 14. For example, the user who has confirmed the estimate management application can talk with the generative AI system 50 to add or delete a field.

FIG. 14 is a diagram illustrating a display of an application generation page in which the user has added a chat message 307 to the application generation page of FIG. 12B. In FIG. 14, the chat message 307 which is “Can the No., item, and quantity be in the sub-table? Also, can you put it before the estimated amount?” is input.

The user terminal 10 transmits the chat message 307 to the information processing system 20, and the information processing system 20 transmits a request message including the chat message 307, the sample data information 231 which is a history of past conversations, and designation of a specification of a function to the generative AI system 50. Accordingly, the generative AI system 50 transmits a function call request (function call) to the information processing system 20, and the information processing system 20 can generate the application for the application service 40 (execution of function).

In FIG. 14, a URL 309 of the application after the update is displayed. The user can press the URL 309 with a mouse pointer to use the updated application.

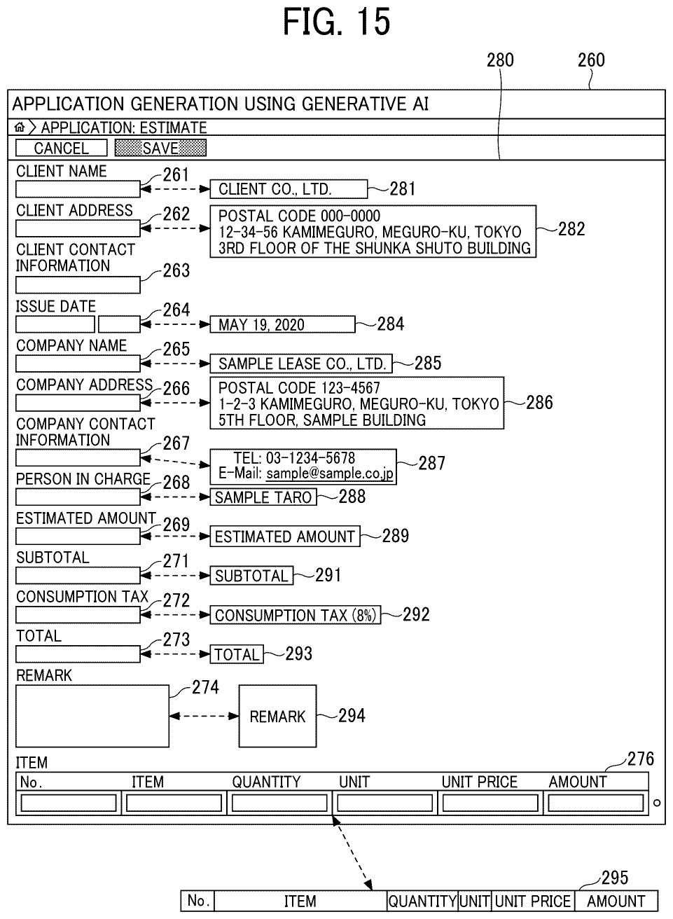

FIG. 15 is a diagram illustrating an estimate management application screen 280 displayed by the estimate management application when the URL 309 of the updated application is pressed. The description given in reference to FIG. 15 mainly includes the differences from FIG. 13. The user requests the information processing system 20 to modify the estimate management application by the chat message 307, and thus the estimate management application screen 280 of FIG. 15 includes a sub-table 276. The sub-table 276 is presumed to have been generated from column headings 295 of the estimate of FIG. 11, but has been generated in tabular form, apart from other items, as desired by the user. As described above, the user can generate the estimate management application with the sample data and then modify the estimate management application with the natural language (chat message).

In order for the information processing system 20 to call the second API 27, the information processing system 20 needs to be authenticated by the application service 40. When the information processing system 20 in the sequence diagram of FIG. 10 operates in the same domain as the application service 40, authentication information of the application service 40 is transmitted from the web browser operating in the user terminal 10 to the information processing system 20. The authentication information is included in, for example, a cookie in advance. Then, the information processing system 20 can call the second API 27 published by the application service 40. When a no-code platform or low-code platform (application service 40) and the information processing system 20 are developed by the same organization, it is considered to be easy for the application service 40 and the information processing system 20 to operate in the same domain, and in this case, it is considered that there is no problem.

However, when the information processing system 20 and the application service 40 operate in different domain, a problem related to authentication may occur. A description is given below with reference to FIG. 16. FIG. 16 is a diagram illustrating a portal screen 330 of the application service 40 displayed by the user terminal 10. The user can use an application or develop an application from the portal screen 330.

For example, it is assumed that the configuration of the portal screen 330 of the application service 40 is as follows. The portal screen 330 displays an “AI application generation” button 331. When the user presses the “AI application generation” button 331, another web page 332 for communicating with the information processing system 20 is opened in a pop-up manner. In this case, since the application service 40 and the information processing system 20 are in different domain, the user terminal 10 cannot transmit the authentication information of the application service 40 to the information processing system 20. Accordingly, the information processing system 20 cannot call the second API 27 published by the application service 40. The web page 332 displayed in a pop-up manner operates in a domain different from that of the portal screen 330, and thus the web page 332 displayed in a pop-up manner cannot access the cookie of the application service 40.

A configuration is considered in which the web page 332 displayed in a pop-up manner requests the original portal screen 330 to call the second API 27 published by the application service 40.

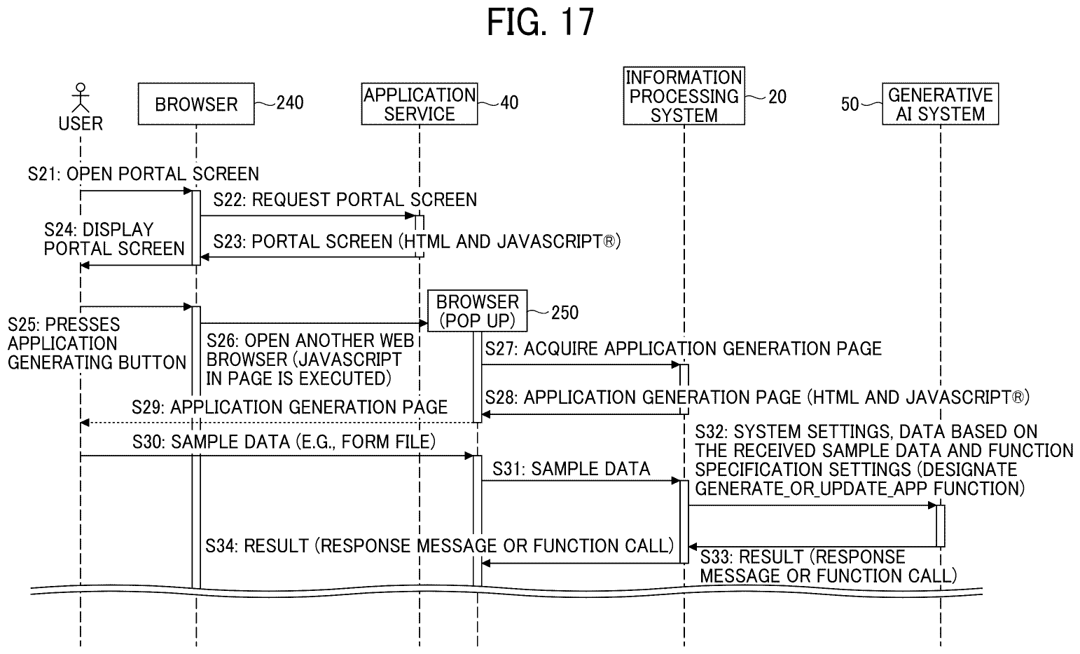

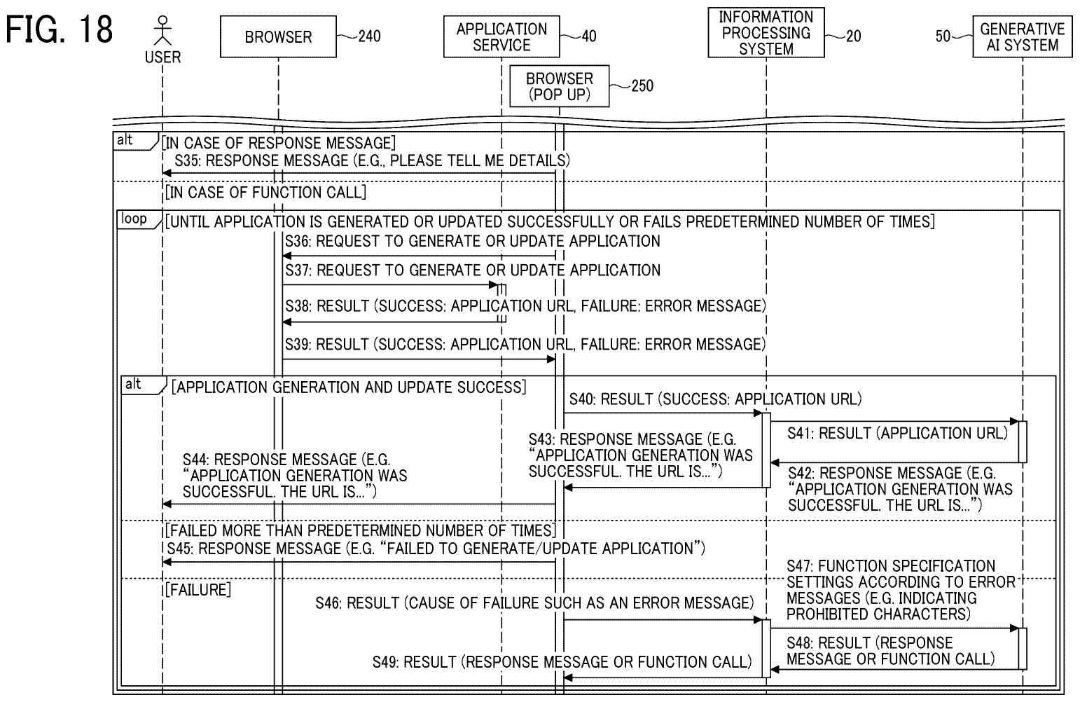

FIGS. 17 and 18 are sequence diagrams that the information processing system 20 utilizes the cooperation of two web browsers in the user terminal 10 to generate or update an application of the application service 40. The description given in reference to FIGS. 17 and 18 may mainly include the differences from FIG. 10. As a large processing flow, steps S36 to S49 are repeatedly executed.

In step S21, the user designates the URL of the application service 40 to the user terminal 10. A web browser 240 (a first web browser) is a web browser that is connected to the application service 40.

In step S22, the communication unit 11 of the user terminal 10 connects to the URL of the application service 40. Since the user designates the URL of the portal screen 330 to the user terminal 10, the web browser 240 of the user terminal 10 transmits an HTTP request including the URL of the portal screen 330 to the application service 40.

In step S23, when the application service 40 receives the HTTP request from the user terminal 10, the application service 40 transmits screen information, for example, an HTML program, a JavaScript® program, and a CSS program of the portal screen 330 to the user terminal 10. The screen information includes a script for activating the other web browser 250 (a second web browser) and a URL of the other web page 332 (an application generation page).

In step S24, the communication unit 11 of the user terminal 10 receives the screen information of the portal screen 330, and the display control unit 12 of the web browser 240 displays the portal screen 330.

In step S25, the user presses the “AI application generation” button 331 on the portal screen 330.

In step S26, accordingly, the inter-browser communication unit 14 activates the other web browser 250. The web browser 250 is displayed in a pop-up manner. More specifically, JavaScript® program included in the screen information of the portal screen 330 activates the web browser 250.

In step S27, the web browser 250 uses the URL of the web page 332 (application generation page) notified from the web browser 240 to request the web page 332 (application generation page) to the information processing system 20.

I step S28, the screen generation unit 22 of the information processing system 20 generates screen information for example, an HTML program, a JavaScript® program, and a CSS program of the application generation page, and the communication unit 21 transmits the screen information of the application generation page to the web browser 250 (user terminal 10).

In step S29, the communication unit 11 of the user terminal 10 receives the screen information of the application generation page. The display control unit 12 displays the application generation page based on the screen information.

In step S30, the user operates the user terminal 10 to select a sample file such as a form file.

Since the processing flow after the user terminal 10 displays the application generation page is the same as the processing flow in FIG. 10, the description given in reference to FIGS. 17 and 18 may mainly include the differences from FIG. 10. Processing of steps S31 to S34 are performed in the same or substantially the same manner as described above with reference to steps S3 to S6 of FIG. 10.

In step S35, when the web browser 250 receives the response message (in this case, the reply message) from the generative AI system 50 in step S34, the display control unit 12 of the web browser 250 displays the reply message (e.g., “Please tell me details.”).

In step S36, when the web browser 250 receives the response message (in this case, the function call request) from the generative AI system 50 in step S34, the inter-browser communication unit 14 of the web browser 250 requests the web browser 240 to generate or update the application of the application services 40. As such communication (message communication) between browsers, the postMessage that is a method of the web API can be used.

In step S37, the web browser 240 generates or updates the application of the application service 40 for the application service 40.

In step S38, the application service 40 transmits a result (success or failure) of the generation or update of the application to the web browser 240. When the generation or update of the application is successful, the URL of the application is notified. When the generation or update of the application is failure, an error message is notified.

In step S39, the inter-browser communication unit 14 of the web browser 240 transmits the result of the generation or update of the application to the web browser 250. After that, when the result is successful, the process proceeds to step S40, and when the result is failure, the process proceeds to step S46.

In step S40, the inter-browser communication unit 14 of the web browser 250 receives the result of success (URL of the application), and the communication unit 11 of the web browser 250 transmits the result (success) of the generation or update of the application to the information processing system 20. In other words, in the processing flow of FIG. 18, the information processing system 20 receives the result from the user terminal 10 (the web browser 250) instead of the application service 40. The subsequent processing in steps S41 to S43 is the same as the processing in steps S9 to S11 of FIG. 10.

In step S44, the communication unit 11 of the web browser 250 receives the reply message. The display control unit 12 displays the reply message on the application generation page. The process of FIG. 18 is ended in step S44, and after that, the user returns to step S30 as needed in order to update the application.

In step S45, when the web browser 250 receives the result (success or failure) of the step S39, the inter-browser communication unit 14 determines whether the result has failed consecutively for a predetermined number of times or more. When the failure has occurred consecutively for the predetermined number of times or more, the display control unit 12 causes the web browser 250 to display a result such as “Failed to generate/update application.” The process of FIG. 18 is ended, and after that, the user returns to step S30 as needed in order to generate the application again.

In step S46, when the inter-browser communication unit 14 of the web browser 250 receives the result of failure (error message), the communication unit 11 of the web browser 250 transmits the result (failure) of the generation or update of the application to the information processing system 20. The subsequent processing of steps S47 and S48 are performed in the same or substantially the same manner as the processing of steps S13 and S14 described above with reference to FIG. 10.

In step S49, the information processing system 20 transmits a function call request or a normal reply message to web browser 250. When the information processing system 20 transmits the function call request, the process proceeds to step S36, and when the information processing system 20 transmits the response message, the process proceeds to step S35.

After that, even in the case of the repetitive processing, the information processing system 20 requests the user terminal 10 to generate or update the application of the application service 40.

Although the web browser 250 displays a pop-up window in FIGS. 17 and 18, a function that is called “iframe” (inline frame) supported by a web browser may be used. The iframe (inline frame) is defined by an element (tag) of HTML, and is a function of displaying another web page or content (text, image, or moving image) in a web page. The iframe (inline frame) can embed another web page in the web page, and thus the application generation page that is another site can be displayed in the portal screen of the application service 40. In this case, the postMessage is known as the communication between windows. The sequence diagram in this case may be the same as that of FIG. 10.

The information processing system 20 according to the present embodiment can solve the two barriers described above in a case where a user with limited expertise develops an application. The first barrier is that the user doesn't know what kind of application to generate, and the second barrier is that the user doesn't know how to generate the application even if the user has an application that the user wants to generate.

In the application generation system 100 according to the present embodiment, a user can operate the user terminal 10 and transmit sample data to the generative AI system 50 to develop an application. Since the information processing system 20 designates a function to the generative AI system 50, the generative AI system 50 can request the information processing system 20 to call the function together with the field name of the application. Then, the information processing system 20 actually generates or updates the application. As a result, from the user's point of view, the user can transmit sample data such as a form file to the information processing system 20 to implement a no-code or low-code platform that can actually develop an application.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

For example, in the present embodiment, the user inputs sample data to the information processing system 20. However, the user may transmit, for example, an image (a photograph, handwriting, or a snapshot) representing a screen of an application to the information processing system 20 to request generation of the application. The information processing system 20 transmits the screen of the application to the generative AI system 50, and the generative AI system 50 analyzes the screen of the application and transmits a function call request to the information processing system 20. The generative AI system 50 can include the field name and the data format extracted from the screen of the application in the function call request.

The sample data may be an image file. For example, the image may be image data acquired by capturing a form file, a receipt, or a business card. The information processing system 20 can perform optical character reader/recognition (OCR) on the image data and extracting characters to generate the application in the same manner as in the present embodiment.

In the present embodiment, the user causes the user terminal 10 to transmit the sample data, but the sample data may be stored in a predetermined server. In this case, the user inputs information designating the sample data on the server to the user terminal 10 in natural language (chat message), and the user terminal 10 transmits the information designating the sample data to the information processing system 20 or the generative AI system 50. The information processing system 20 or the generative AI system 50 acquires the sample data from the server and generates the application.

In the present embodiment, the information processing system 20 transmits the URL of the application to the generative AI system 50, but the URL may be any access information for accessing the application. For example, when the application service 40 returns the identification information (ID) of the generated application to the information processing system 20, the information processing system 20 transmits the ID of the application to the generative AI system 50. The information processing system 20 transmits the ID of the application included in the response message returned from the generative AI system 50 to the user terminal 10. When the user terminal 10 designates the ID of the application to request execution of the application, the information processing system 20 converts the ID into the URL of the application and returns the URL to the user terminal 10.

In the present embodiment, the information processing system 20 receives a function call request from the generative AI system 50. However, the information processing system 20 may receive a call request of the Web-API directly from the generative AI system 50. In other words, the function and the API may not be strictly distinguished from each other.

The apparatuses or devices described in the above-described embodiments are merely one example of multiple computing environments that implement the embodiments disclosed herein. In some embodiments, the information processing system 20 includes multiple computing devices, such as a server cluster. The multiple computing devices are configured to communicate with one another through any type of communication link including, for example, a network or a shared memory, and perform the processes disclosed in the preset specification.

The information processing system 20 can be configured to share the disclosed processing steps, for example, the processes illustrated in FIG. 10, in various combinations. For example, a process performed by a given unit may be performed by multiple information processing apparatuses included in the information processing system 20. The elements of the information processing system 20 are combined into one server apparatus or are divided into multiple apparatuses.

The configuration illustrated in, for example, FIG. 5 are divided according to main functions in order to facilitate understanding of processing by the information processing system 20. The scope of the present disclosure is not limited by how the process units are divided or by the names of the process units. The processes implemented by the information processing system 20 can be divided to a larger number of processes depending on the contents of processes. One process may be divided to include the larger number of processes.

The functionality of the elements disclosed herein may be implemented using circuitry or processing circuitry which includes general purpose processors, special purpose processors, integrated circuits, application-specific integrated circuits (ASICs), field-programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD-ROM or DVD, and/or the memory of an FPGA or ASIC.

A description is given below of a configuration in which the application service 40 and the information processing system 20 are integrated. In the following description, the information processing system 20 includes the function of the application service 40, but the application service 40 may include the function of the information processing system 20.

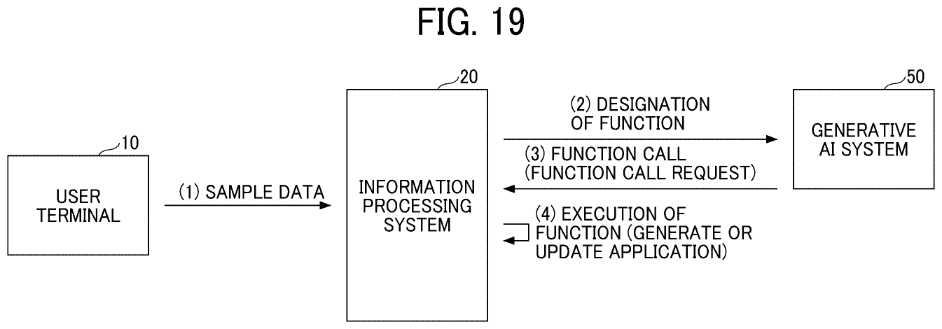

FIG. 19 is a diagram illustrating processing from when the generative AI system 50 requests the information processing system 20 to execute a function in response to a chat message input by the user until when the information processing system 20 generates an application. The processes (1) to (3) of FIG. 19 may be the same or substantially the same as those described with reference to FIG. 1.

In step (4), the information processing system 20 generates an application in response to the function call request (function call) included in the response message transmitted from the generative AI system 50. The type of application to be generated is determined by steps (2) and (3). More specifically, the information processing system 20 executes a function for generating the application from the content of the function call request (function call). In other words, in the case of the configuration of FIG. 19, the information processing system 20 itself generates or updates the application.

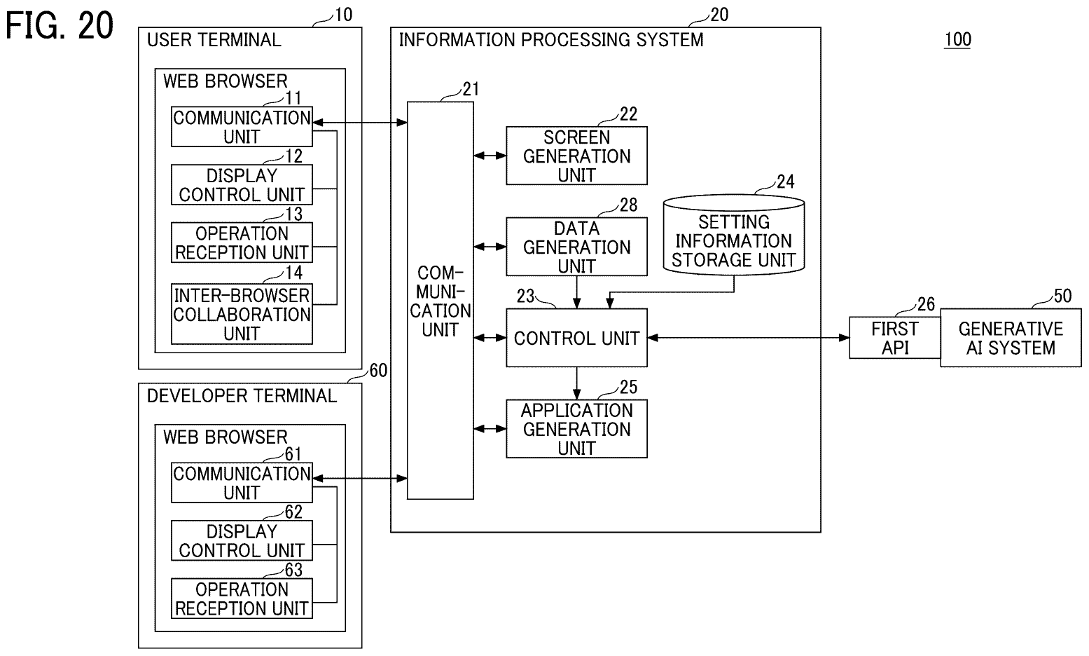

FIG. 20 is a diagram illustrating a functional configuration of the information processing system 20, the user terminal 10, and the developer terminal 60 in the case where the application service 40 and the information processing system 20 are integrated. The description given in reference to FIG. 20 mainly includes the differences from FIG. 5. Since the information processing system 20 and the application service 40 are integrated, the application generation unit 25 does not call the second API 27. The functions of the communication unit 21, the screen generation unit 22, the setting information storage unit 24, the data generation unit 28, and the control unit 23 may be the same as those in FIG. 5.

The application generation unit 25 of FIG. 20 functions by executing a predefined function. Parameters to be input to the function to be executed include a field name of the database and a data format.

The present disclosure provides significant improvements in computer capabilities and functionalities. These improvements allow users to utilize a computer which provides for more efficient and robust interaction with a table which is a way to store and present information in an information processing apparatus. The present disclosures provides for a better user experience through the use of a more efficient, powerful, and robust user interface. Such a user interface provides a better interaction between a human and a machine.

A description is given below of some aspects of the present disclosure.

### Aspect 1

An information processing apparatus that can communicate with a terminal device and a generative artificial intelligence (AI) system via a network includes an application generation unit and a control unit. The application generation unit functions by executing a predefined function, and generates an application related to a request for generation of the application based on a parameter included in the request. When sample data for application generation is received from the terminal device, the control unit transmits data based on the received sample data to the generative AI system. The control unit transmits setting information for generating the application and information for calling the function to the generative AI system at least once. When the control unit receives the request transmitted by the generative AI system based on the data transmitted to the generative AI system, the setting information transmitted to the generative AI system, and the information for calling the function transmitted to the generative AI system, the application generation unit generates the application related to the request based on the parameter included in the received request.

### Aspect 2

In the information processing apparatus according to Aspect 1, when the control unit receives a reply message to the data transmitted to the generative AI system from the generative AI system, the control unit transmits the reply message to the terminal device.

### Aspect 3

In the information processing apparatus according to Aspect 2, the control unit transmits access information for accessing the generated application to the generative AI system in order to include the access information in the reply message.

### Aspect 4

In the information processing apparatus according to Aspect 3, when the control unit receives the reply message including the access information from the generative AI system as a response to the transmission of the access information to the generative AI system, the control unit transmits the reply message including the access information to the terminal device.

### Aspect 5

The information processing apparatus according to any one of Aspects 1 to 4, the information for calling the function includes setting of a specification of the function to be called by the generative AI system. A function call request for calling the function transmitted from the generative AI system to the information processing apparatus based on the setting of the specification of the function includes a request related to generation of the application. The control unit receives the request related to generation of the application from the generative AI system.

### Aspect 6

In the information processing apparatus according to Aspect 3, when the control unit receives the request for generation of the application from the generative AI system, the application generation unit generates the application related to the request based on the parameter. When the control unit receives the reply message to the data, not the request related to the generation of the application, from the generative AI system, the control unit transmits the response message to the terminal device.

### Aspect 7

In the information processing apparatus according to any one of Aspects 1 to 6, when the application generation unit fails to generate the application, the control unit receives an error message acquired due to the failure to generate the application, transmits the data again to the generative AI system, and receives a request for generation of the application as a response to the error message and the data from the generative AI system.

### Aspect 8

In the information processing apparatus according to any one of Aspect 1 to 6, when the application generation unit fails to generate the application for a predetermined number of times, the control unit transmits a notification that the generation of the application has failed to the terminal device.

### Aspect 9

In the information processing apparatus according to any one of Aspect 1 to 7, when the application is an application whose information is registered in a table, the parameter is one or more field names of the table.

### Aspect 10

The information processing apparatus according to any one of Aspect 1 to 8 communicates with an application service that executes the application via a network, and the application generation unit designates the parameter and requests the application service to generate the application.

### Aspect 11

In the information processing apparatus according to Aspect 10, the terminal device executes a first web browser that communicates with the application service and a second web browser activated by the first web browser. The information processing apparatus receives data based on the sample data from the second web browser. When the control unit receives a request for generation of the application transmitted by the generative AI system, the application generation unit transmits the request for generation of the application to the second web browser. The second web browser transmits the request for generation of the application to the first web browser. The first web browser transmits the request for generation of the application to the application service.

### Aspect 12

The information processing apparatus according to any one of Aspects 1 to 11 includes a data generation unit that converts the received sample data into a predetermined format to generate the data. The control unit transmits the generated data to the generative AI system.

### Aspect 13

In the information processing apparatus according to any one of Aspects 1 to 12, the data based on the received sample data is the same data as the sample data.

### Aspect 14

In the information processing apparatus according to any one of Aspects 1 to 12, the sample data is a file in a format of Microsoft® Excel, Microsoft® Word, or portable document format (PDF).

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

1. An information processing apparatus communicably connected with a terminal device and a generative artificial intelligence (AI) system through a network, the apparatus comprising:
processing circuitry configured to:
in response to receiving sample data for generating application from the terminal device, transmit data based on the sample data to the generative AI system;
transmit setting information for generation of the application and information for calling a predefined function to the generative AI system at least once; and
in response to receiving a request for generation of the application from the generative AI system, generate the application based on parameters included in the request by executing the predefined function,
the request being generated by the generative AI system based on the data, the setting information, and the information for calling the predefined function.

2. The information processing apparatus according to claim 1,
wherein, in response to receiving a reply message to the data transmitted to the generative AI system from the generative AI system, the processing circuitry is configured to transmit the reply message to the terminal device.

3. The information processing apparatus according to claim 2,
wherein the processing circuitry is configured to transmit access information for accessing the generated application to the generative AI system, the access information to be included in the reply message by the generative AI system.

4. The information processing apparatus according to claim 3,
wherein, when the processing circuitry receives the reply message including the access information from the generative AI system in response to the transmission of the access information to the generative AI system, the processing circuitry is configured to transmit the reply message including the access information to the terminal device.

5. The information processing apparatus according to claim 1,
wherein the information for calling the predefined function includes setting of a specification of the predefined function to be called by the generative AI system, and
wherein a function call request for calling the predefined function transmitted from the generative AI system to the information processing apparatus based on the setting of the specification of the predefined function includes the request for generation of the application.

6. The information processing apparatus according to claim 3,
wherein, when the processing circuitry receives the request for generation of the application from the generative AI system, the processing circuitry is configured to generate the application based on the parameters, and
wherein, when the processing circuitry receives the reply message to the data from the generative AI system, the processing circuitry is configured to transmit the response message to the terminal device.

7. The information processing apparatus according to claim 1,
wherein, when the processing circuitry fails to generate the application, the processing circuitry is configured to:
transmit an error message acquired due to the failure of generating the application;
transmit the data again to the generative AI system; and
receive a request for generation of the application as a response to the error message and the data from the generative AI system.

8. The information processing apparatus according to claim 1,
wherein, when the processing circuitry fails to generate the application for a predetermined number of times, the processing circuitry is configured to transmit a notification that the generation of the application has failed to the terminal device.

9. The information processing apparatus according to claim 1,
wherein when the application is an application whose information is registered in a table, the parameters include one or more field names of the table.

10. The information processing apparatus according claim 1,
wherein the processing circuitry of the information processing apparatus is configured to communicate with an application service that executes the application through the network, and
wherein the processing circuitry is configured to designate the parameters and requests the application service to generate the application.

11. The information processing apparatus according to claim 1,
wherein the processing circuitry is configured to convert the sample data into the data based on the sample data having a predetermined format.

12. The information processing apparatus according to claim 1,
wherein the data based on the sample data is the same data as the sample data.

13. The information processing apparatus according to claim 1,
wherein the sample data is an electronic file in a format of Microsoft® Excel, Microsoft® Word, or portable document format (PDF).

14. An application generation system comprising:
a terminal device;
a generative AI system; and
an information processing apparatus communicably connected with the terminal device and the generative AI system through a network,
the terminal device including device circuitry configured to transmit sample data for generating application to the generative AI system,
the information processing apparatus including processing circuitry configured to:
in response to receiving sample data for generating application from the terminal device, transmit data based on the sample data to the generative AI system;
transmit setting information for generating the application and information for calling a predefined function to the generative AI system at least once; and
in response to receiving a request for generation of the application from the generative AI system, generate the application based on parameters included in the request by executing the predefined function,
the request being generated by the generative AI system based on the data, the setting information, and the information for calling the predefined function.

15. The application generation system according to claim 14,
wherein the device circuitry of the terminal device is configured to execute a first web browser that communicates with the application service and a second web browser activated by the first web browser,
wherein the processing circuitry of the information processing apparatus is configured to receive the data based on the sample data from the second web browser,
wherein, when the processing circuitry is configured to receive the request for generation of the application transmitted by the generative AI system, the processing circuitry is configured to transmit the request for generation of the application to the second web browser,
wherein the second web browser is configured to transmit the request for generation of the application to the first web browser, and
wherein the first web browser is configured to transmit the request for generation of the application to the application service.

16. An application generation method for generating application, executed by an information processing apparatus communicably connected with a terminal device and a generative AI system through a network, the method comprising:
in response to receiving sample data for generating application from the terminal device, transmitting data based on the sample data to the generative AI system;
transmitting setting information for generating the application and information for calling a predefined function to the generative AI system at least once; and
in response to receiving a request for generation of the application from the generative AI system, generating the application based on parameters included in the request by executing the predefined function,
the request being generated by the generative AI system based on the data, the setting information, and the information for calling the predefined function.
